(19) United States
(12) Patent Application Publication
(10) Pub. No.: US 2025/0031104 A1
(43) Pub. Date: Jan. 23, 2025

(54) MOBILITY REPORTING FOR NON-SERVING CELLS BASED ON MACHINE LEARNING

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Tao Luo, San Diego, CA (US); Sony Akkarakaran, Poway, CA (US); Jelena Damnjanovic, Del Mar, CA (US); Taesang Yoo, San Diego, CA (US); Wooseok Nam, San Diego, CA (US); Junyi Li, Greentown, PA (US)

(21) Appl. No.: 18/710,580

(22) PCT Filed: Jan. 21, 2022
(86) PCT No.: PCT/CN2022/073095

§ 371 Date: May 15, 2024

(51) Int. Cl. H04W 36/00; H04B 7/06

(52) U.S. Cl. CPC H04W 36/0058; H04B 7/0626

(57) ABSTRACT

Methods, systems, and devices for wireless communications are described. A user equipment (UE) may establish communications between the UE and a serving cell. The serving cell may be different than each non-serving cell of a set of non-serving cells for the UE. The UE may use machine learning models to determine outputs associated with mobility measurement reporting for the UE. The outputs may indicate whether to perform measurements associated with the set of non-serving cells, whether to report the measurements associated with the set of non-serving cells, one or more non-serving cells within the set of non-serving cells for performing or reporting the measurements, or one or more reference signals of the one or more non-serving cells for performing the measurements, or any combination thereof. The UE may perform the mobility measurement reporting based on the outputs.

### CROSS REFERENCE

The present application is a 371 national stage filing of International PCT Application No. PCT/CN2022/073095 by Li et al. entitled “MOBILITY REPORTING FOR NON-SERVING CELLS BASED ON MACHINE LEARNING,” filed Jan. 21, 2022, which is assigned to the assignee hereof, and which is expressly incorporated by reference in its entirety herein.

### FIELD OF TECHNOLOGY

The following relates to wireless communications, including mobility reporting for non-serving cells based on machine learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support mobility reporting in which a UE may be configured to perform and report reference signal measurements to a serving cell. A mobility report may include measurements performed on reference signals associated with the serving cell and one or more non-serving (e.g., neighboring) cells. In some examples, however, mobility reporting for non-serving cells may result in increased power consumption and may degrade the performance of the UE.

### SUMMARY

The described techniques relate to improved methods, systems, devices, and apparatuses that support mobility reporting for non-serving cells based on machine learning. For example, a user equipment (UE) may establish communications between the UE and a serving cell. The serving cell may be different than each non-serving cell of a set of non-serving cells for the UE. The UE may use machine learning models to determine outputs associated with mobility measurement reporting for the UE. The outputs may indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The UE may perform the mobility measurement reporting based on the outputs. For example, an output may indicate for the UE to perform measurements associated with the set of non-serving cells and based on the output, the UE may perform measurements for each non-serving cell of the set. In some examples, mobility reporting for non-serving cells based on machine learning, as described herein, may reduce network inefficiencies, among other possible benefits.

A method for wireless communication at a UE is described. The method may include establishing communications between the UE and a serving cell, the serving cell different than each non-serving cell of a set of non-serving cells for the UE, using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof, and performing the mobility measurement reporting based on the one or more outputs.

An apparatus for wireless communication is described. The apparatus may include memory, a transceiver, and at least one processor of a UE, the at least one processor coupled with the memory and the transceiver. The at least one processor may be configured to cause the apparatus to establish communications between the UE and a serving cell, the serving cell different than each non-serving cell of a set of non-serving cells for the UE, use one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof, and perform the mobility measurement reporting based on the one or more outputs.

Another apparatus for wireless communication at a UE is described. The apparatus may include means for establishing communications between the UE and a serving cell, the serving cell different than each non-serving cell of a set of non-serving cells for the UE, means for using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof, and means for performing the mobility measurement reporting based on the one or more outputs.

A non-transitory computer-readable medium storing code for wireless communication at a UE is described. The code may include instructions executable by a processor to establish communications between the UE and a serving cell, the serving cell different than each non-serving cell of a set of non-serving cells for the UE, used one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof, and perform the mobility measurement reporting based on the one or more outputs.

In some examples of the method, apparatuses, and non-transitory computer-readable medium described herein, the one or more outputs indicate for the UE to perform and report the measurements associated with the set of non-serving cells, and where to perform the mobility measurement reporting may include operations, features, means, or instructions for performing, for each non-serving cell of the set of non-serving cells, one or more measurements based on each reference signal indicated by a channel state information (CSI) resource setting associated with the set of non-serving cells and received from the serving cell.

Some examples of the method, apparatuses, and non-transitory computer-readable medium described herein may further include operations, features, means, or instructions for transmitting, to the serving cell, a report indicating the one or more measurements, the one or more outputs that indicate for the UE to perform and report the measurements associated with the set of non-serving cells, or both.

In some examples of the method, apparatuses, and non-transitory computer-readable medium described herein, the one or more outputs may indicate the one or more non-serving cells of the set of non-serving cells for performing or reporting the measurements, and where, to perform the mobility measurement reporting, the method, apparatuses, and non-transitory computer-readable medium described herein may include operations, features, means, or instructions for performing one or more measurements for each of the one or more non-serving cells based on the one or more outputs, where the one or more measurements may be based on each reference signal indicated by a CSI resource setting associated with the set of non-serving cells and received from the serving cell, and where the one or more non-serving cells include a subset of the set of non-serving cells and transmitting, via the transceiver and to the serving cell, a report indicating the one or more measurements for each of the one or more non-serving cells, one or more identifiers for each of the one or more non-serving cells, or both.

In some examples of the method, apparatuses, and non-transitory computer-readable medium described herein, performing the mobility measurement reporting may include operations, features, means, or instructions for performing one or more measurements for each of the one or more reference signals based on the one or more outputs, where the one or more reference signals including a subset of reference signals indicated by a CSI resource setting associated with the one or more non-serving cells and received from the serving cell and transmitting, to the serving cell, a report indicating the measurements for the one or more reference signals, one or more identifiers for the one or more non-serving cells, one or more identifiers for the one or more reference signals, or any combination thereof.

In some examples of the method, apparatuses, and non-transitory computer-readable medium described herein, each non-serving cell of the set of non-serving cells may be associated with a cell identifier different from a cell identifier associated with the serving cell and the serving cell includes an activated serving cell.

Some examples of the method, apparatuses, and non-transitory computer-readable medium described herein may further include operations, features, means, or instructions for identifying one or more reference signal identifiers and one or more measurement values associated with each of the one or more reference signal identifiers, where the one or more reference signal identifiers may be associated with the serving cell, a subset of non-serving cells of the set of non-serving cells, a subset of reference signals associated with the subset of non-serving cells, or any combination thereof and inputting the one or more reference signal identifiers and the one or more measurement values associated with each of the one or more reference signal identifiers into the one or more machine learning models, where the one or more outputs may be based on the inputting.

In some examples of the method, apparatuses, and non-transitory computer-readable medium described herein, the one or more measurement values include reference signal received power values, signal-to-interference-plus-noise ratio values, power delay profile values, angle of arrival values, or any combination thereof.

Some examples of the method, apparatuses, and non-transitory computer-readable medium described herein may further include operations, features, means, or instructions for receiving, from the serving cell, a CSI resource setting for non-serving cell measurement mobility reporting, the CSI resource setting indicating the subset of non-serving cells, the subset of reference signals associated with the subset of non-serving cells, or both, where identifying the one or more reference signal identifiers and the one or more measurement values associated with each of the one or more reference signal identifiers may be based on receiving the CSI resource setting.

Some examples of the method, apparatuses, and non-transitory computer-readable medium described herein may further include operations, features, means, or instructions for inputting one or more additional inputs into the one or more machine learning models, the one or more additional inputs including at least one of traffic load information associated with the communications between the UE and the serving cell, crosslink interference measurement values associated with crosslink interference at the UE, the serving cell, or both, sidelink measurement values associated with sidelink communications at the UE, UE position information, or any combination thereof, where the one or more outputs may be further based on the one or more additional inputs.

In some examples of the method, apparatuses, and non-transitory computer-readable medium described herein, each machine learning model of the one or more machine learning models may be associated with a respective serving cell identifier, a respective non-serving cell identifier, a respective non-serving cell identifier group, or any combination thereof.

In some examples of the method, apparatuses, and non-transitory computer-readable medium described herein, using the one or more machine learning models to determine the one or more outputs associated with the mobility measurement reporting for the UE may include operations, features, means, or instructions for using a first machine learning model associated with a first machine learning model type to determine a first output associated with the mobility measurement reporting for the UE, the first output indicating for the UE to perform and report the measurements associated with the set of non-serving cells and using a second machine learning model associated with a second machine learning model type to determine a second output associated with the mobility measurement reporting of the UE, the second output indicating the one or more non-serving cells of the set of non-serving cells for performing or reporting the measurements, where an input of the second machine learning model includes the first output, and where performing the mobility measurement reporting may be based on the second output.

Some examples of the method, apparatuses, and non-transitory computer-readable medium described herein may further include operations, features, means, or instructions for using a third machine learning model associated with a third machine learning model type to determine a third output associated with the mobility measurement reporting of the UE, the third output indicating the one or more reference signals of the one or more non-serving cells for performing the measurements, where the input of the third machine learning model includes at least one of the first output and the second output, and where performing the mobility measurement reporting may be based on the third output.

Some examples of the method, apparatuses, and non-transitory computer-readable medium described herein may further include operations, features, means, or instructions for refraining from running a first machine learning model associated with a first output that indicates the one or more non-serving cells within the set of non-serving cells for performing or reporting the measurements, refraining from running a second machine learning model associated with a second output that indicates the one or more reference signals of the one or more non-serving cells for performing the measurements, or both.

In some examples of the method, apparatuses, and non-transitory computer-readable medium described herein, and the method, apparatuses, and non-transitory computer-readable medium may include further operations, features, means, or instructions for using a first machine learning model of a first machine learning model type to determine a first output and using a second machine learning model to determine a second output that may be included in the one or more outputs, the second machine learning model associated with the first machine learning model type or a second machine learning model type different from the first machine learning model type.

In some examples of the method, apparatuses, and non-transitory computer-readable medium described herein, the first output includes an indication for the UE to switch from the first machine learning model to the second machine learning model and using the second machine learning model to determine the second output may be based on the indication for the UE to switch.

In some examples of the method, apparatuses, and non-transitory computer-readable medium described herein, the indication includes a probability associated with the UE switching from the first machine learning model to the second machine learning model and using the second machine learning model to determine the second output may be based on the probability satisfying a threshold.

Some examples of the method, apparatuses, and non-transitory computer-readable medium described herein may further include operations, features, means, or instructions for receiving an indication of the threshold from the serving cell.

Some examples of the method, apparatuses, and non-transitory computer-readable medium described herein may further include operations, features, means, or instructions for transmitting, to the serving cell, an indication that the UE switched from the first machine learning model to the second machine learning model.

Some examples of the method, apparatuses, and non-transitory computer-readable medium described herein may further include operations, features, means, or instructions for receiving, from the serving cell, an indication of the one or more machine learning models or a machine learning model type associated with the one or more machine learning models, where using the one or more machine learning models to determine the one or more outputs associated with the mobility measurement reporting for the UE may be based on the indication.

Some examples of the method, apparatuses, and non-transitory computer-readable medium described herein may further include operations, features, means, or instructions for transmitting, to the serving cell, a first mobility measurement report, where the indication of the one or more machine learning models or the machine learning model type associated with the one or more machine learning models may be based on the first mobility measurement report, an availability of uplink resources, or both.

Some examples of the method, apparatuses, and non-transitory computer-readable medium described herein may further include operations, features, means, or instructions for transmitting, to the serving cell, an indication of one or more capabilities associated with the mobility measurement reporting for the UE, where the indication of the one or more machine learning models or the machine learning model type associated with the one or more machine learning models may be based on the one or more capabilities.

In some examples of the method, apparatuses, and non-transitory computer-readable medium described herein, the one or more outputs further indicate a periodicity associated with the mobility measurement reporting for the UE and performing and reporting the measurements associated with the set of non-serving cells may be based on the periodicity.

Some examples of the method, apparatuses, and non-transitory computer-readable medium described herein may further include operations, features, means, or instructions for transmitting, to the serving cell, an indication of the periodicity associated with the mobility measurement reporting for the UE.

In some examples of the method, apparatuses, and non-transitory computer-readable medium described herein, performing the mobility measurement reporting may include operations, features, means, or instructions for transmitting, to the serving cell, a mobility measurement report including layer one mobility measurements.

In some examples of the method, apparatuses, and non-transitory computer-readable medium described herein, performing the mobility measurement reporting may include operations, features, means, or instructions for transmitting, to the serving cell, a mobility measurement report including layer three mobility measurements.

### BRIEF DESCRIPTION OF THE DRAWINGS

FIGS. 1 and 2 each illustrate an example of a wireless communications system that supports mobility reporting for non-serving cells based on machine learning in accordance with aspects of the present disclosure.

FIG. 3 illustrates an example of a multi-stage model procedure that supports mobility reporting for non-serving cells based on machine learning in accordance with aspects of the present disclosure.

FIG. 4 illustrates an example of a process flow that supports mobility reporting for non-serving cells based on machine learning in accordance with aspects of the present disclosure.

FIGS. 5 and 6 show block diagrams of devices that support mobility reporting for non-serving cells based on machine learning in accordance with aspects of the present disclosure.

FIG. 7 shows a block diagram of a communications manager that supports mobility reporting for non-serving cells based on machine learning in accordance with aspects of the present disclosure.

FIG. 8 shows a diagram of a system including a device that supports mobility reporting for non-serving cells based on machine learning in accordance with aspects of the present disclosure.

FIGS. 9 through 12 show flowcharts illustrating methods that support mobility reporting for non-serving cells based on machine learning in accordance with aspects of the present disclosure.

### DETAILED DESCRIPTION

In some wireless communications systems, a communications device (e.g., a base station) may provide a geographic coverage area over which other communication devices (e.g., user equipments (UEs)) may perform wireless communication with the base station. For example, the base station may support a cell (e.g., a logical communication entity) used for communications with the base station (e.g., via a carrier) over the geographic coverage area. In some examples, a serving cell may refer to a cell in which the UE may be camped. That is, the serving cell may refer to a cell selected (e.g., chosen from multiple neighboring cells) by the UE during a cell selection or cell reselection process, such as a handover process. Accordingly, the serving cell may be referred to as an activated serving cell. The serving cell may be associated with a cell identifier (e.g., a physical cell identifier (PCID) or a virtual cell identifier (VCID)) that may distinguish the serving cell from other (e.g., neighboring) cells supported by other (e.g., neighboring) base stations.

Some wireless communications systems may support mobility reporting in which the UE may be configured to perform and report reference signal measurements to the serving cell (e.g., the activated serving cell). In some examples, mobility reporting (e.g., mobility measurement reporting) may include reference signal measurement and reporting for the serving cell and one or more neighboring cells, that may be referred to as non-serving cells. In some examples, the serving cell may be an activated serving cell, and the non-serving cells may be non-activated cells (e.g., non-activated serving cells) associated with cell identifiers that are different from the cell identifier of the activated serving cell. For example, the non-serving cells may be cells that are associated with cell identifiers different from the cell identifier of the cell in which the UE is reporting measurement results to.

The UE may be triggered to send a mobility report for one or more non-serving cells to the serving cell based on events, such as the quality of service provided by the serving cell failing to satisfy a threshold. For high frequency communications (e.g., communications at millimeter wavelengths) the geographic coverage area of the serving cell and non-serving cells may be relatively small and relatively closely spaced, for example compared to coverage areas for low frequency communications (e.g., communications at kilometer wavelengths). As a result, the events which trigger reference signal measurement and reporting may occur relatively frequently (e.g., the UE may perform cell selection or cell reselection processes relatively frequently) resulting in increased latency associated with the mobility measurement reporting. Reduced geographic coverage areas may also result in an increased number of non-serving cells surrounding (e.g., neighboring) the serving cell. As such, the number of non-serving cell reference signals to be measured and reported by the UE may also increase. Accordingly, power consumption, processing, and overhead associated with mobility measurement reporting may increase and degrade the performance of the UE.

One or more aspects of the present disclosure provide for mechanisms that enable a UE to use machine learning models for determining aspects of performing or reporting (e.g., or both) reference signal measurements for non-serving cells. For example, the UE may be configured with one or more machine learning models that may provide various outputs associated with non-serving cell reference signal measurements or reporting. A first type of output may indicate whether non-serving cell reference signals may be measured or associated measurements reported to the serving cell. A second type of output may indicate one or more non-serving cells (e.g., via cell identifiers associated with non-serving cells) from which reference signals may be measured or associated measurements reported to the serving cell. A third type of output may indicate, for the one or more non-serving cells for which measurement or reporting is to be performed, one or more associated reference signals (e.g., via reference signal identifiers) upon which to perform such measurement or reporting. Such techniques may reduce the likelihood of the UE unnecessarily performing mobility-related measurement and reporting for non-serving cells, particular non-serving cells, or particular non-serving cell reference signals.

In some examples, input for the machine learning models at the UE may include reference signal identifiers associated with the serving cell or non-serving cells, beam quality metrics correspond to the reference signal identifiers, or both. For example, the serving cell may indicate the non-serving cells or reference signals associated with the non-serving cells to the UE (e.g., via cell identifiers of non-serving cells or via reference signal identifiers). In some examples, the input for a machine learning model may depend on the output of another (e.g., a previously used) machine learning mode. For example, the input of a second machine learning model may include the output of a first machine learning model and the input for a third machine learning model may include the output of the first machine learning model, the second machine learning model, or both.

Additionally or alternatively, the output of a machine learning model may indicate for the UE to switch machine learning models. For example, the output of the first machine learning model may provide an indication for the UE to switch from the first machine learning model to another model (e.g., the second machine learning model or the third machine learning model). In some examples, rather than outputting a rigid decision (e.g., whether to switch models), a machine learning model may output a probability associated with the UE switching machine learning models. In such an example, the UE may determine to switch models if the probability output by the machine learning model satisfies a threshold (e.g., indicated to the UE by the serving cell).

Particular aspects of the subject matter described herein may be implemented to realize one or more advantages. The described techniques may support improvements in wireless communications systems by reducing signaling overhead. Further, in some examples, using machine learning models for determining aspects of performing or reporting reference signal measurements for non-serving cells, as described herein, may support reduced processing and power consumption at the UE, thereby improving performance. As such, supported techniques may provide improved network operations, and, in some examples, may promote network efficiencies, among other benefits.

Aspects of the disclosure are initially described in the context of wireless communications systems. Aspects of the disclosure are also described in the context of a multi-stage model procedure and a process flow. Aspects of the disclosure are further illustrated by and described with reference to apparatus diagrams, system diagrams, and flowcharts that relate to mobility reporting for non-serving cells based on machine learning.

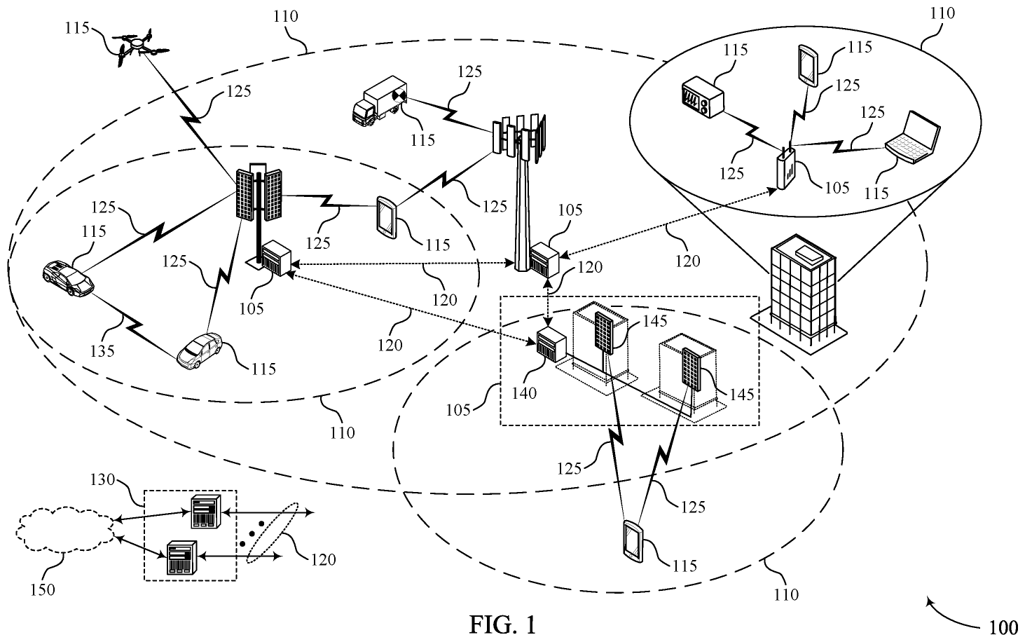

FIG. 1 illustrates an example of a wireless communications system 100 that supports mobility reporting for non-serving cells based on machine learning in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a PCID, a VCID, or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support mobility reporting in which a UE 115 may be configured to perform and report reference signal measurements to a serving cell (e.g., supported by a base station 105). In some examples, mobility reporting may include measurement and reporting of reference signals associated with the serving cell and one or more non-serving cells (e.g., neighboring cells). In some examples, however, mobility reporting for non-serving cells may result in increased processing and power consumption and may degrade the performance of the UE 115. Therefore, to reduce processing associated with performing and reporting measurements of reference signals associated with non-serving cells, the UE 115 may perform mobility reporting for non-serving cells based on machine learning.

For example, the UE 115 may establish communications with a serving cell (e.g., supported by the base station 105). The serving cell may be different than each non-serving cell of a set of non-serving cells for the UE 115. The UE 115 may use machine learning models to determine outputs associated with mobility measurement reporting for the UE 115. The outputs may indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The UE 115 may perform the mobility measurement reporting based on the outputs, thereby reducing network inefficiencies and improving performance at the UE 115.

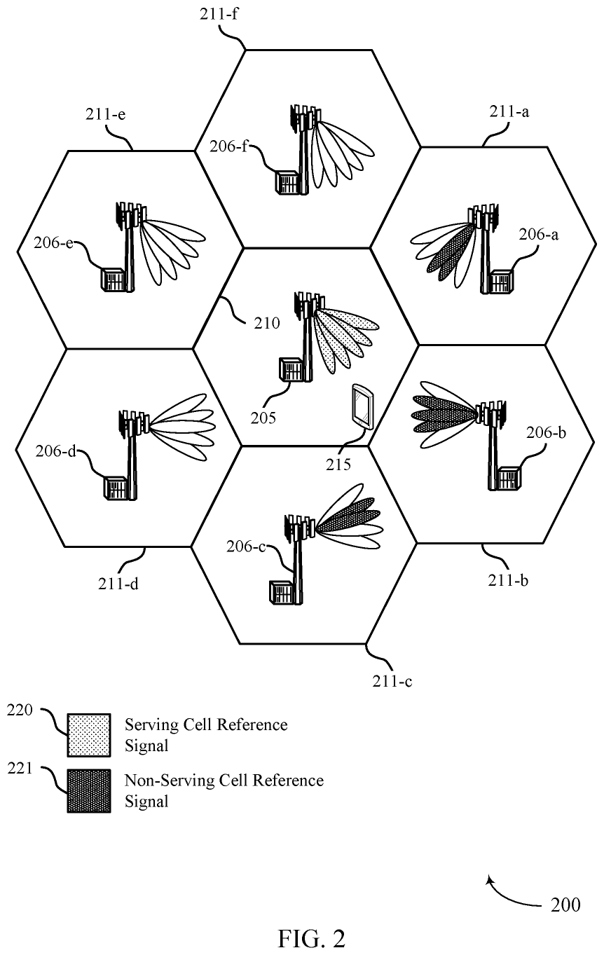

FIG. 2 illustrates an example of a wireless communications system 200 that supports mobility reporting for non-serving cells based on machine learning in accordance with aspects of the present disclosure. The wireless communications system 200 may implement or be implemented by one or more aspects of the wireless communications system 100. For example, the wireless communications system 200 may include a UE 215, which may be an example of a UE 115 described with reference to FIG. 1. The wireless communications system 200 may also include a serving base station 205 and one or more non-serving base stations 206, which may be examples of a base station 105 described with reference to FIG. 1.

In the example of FIG. 2, the serving base station 205 may be a base station supporting a serving cell (e.g., an activated serving cell) whereas the non-serving base stations 206 (e.g., a non-serving base station 206-a, a non-serving base station 206-b, a non-serving base station 206-c, a non-serving base station 206-d, a non-serving base station 206-e, and a non-serving base station 206-f) may be base stations supporting non-serving cells (e.g., non-activated serving cells). The serving base station 205 may support wired or wireless communications within a geographic coverage area 210 and the non-serving base stations 206 may support wired or wireless communications within a respective geographic coverage area 211 (e.g., a geographic coverage area 211-a, a geographic coverage area 211-b, a geographic coverage area 211-c, a geographic coverage area 211-d, a geographic coverage area 211-e, or a geographic coverage area 211-f). The geographic coverage area 210 and the geographic coverage areas 211 may be examples of a geographic coverage area 110 described with reference to FIG. 1.

The UE 215 may be a mobile UE that can travel throughout the geographic coverage area 210 and the geographic coverage areas 211. The UE 215 may perform an initial access procedure to establish a connection with the serving base station 205. For example, while in a connected mode (e.g., a radio resource control (RRC) connected mode), the UE 215 may receive downlink communications from the serving base station 205 via a directional beam, such as may be used to transmit one or more serving cell reference signals 220. As the UE 215 travels throughout the geographic coverage area 210 (e.g., or into another geographic coverage area, such as one or more geographic coverage area 211), the established connection (e.g., a communication link that may also be referred to as a radio link or a link) may be susceptible to blockages and degradation, which may cause interruptions in the radio link or a radio link failure. That is, the downlink communications from the serving base station 205 may be dropped. To reduce the likelihood of radio link failures occurring or to recover after a radio link failure, the UE 215 may perform beam management procedures, such as a beam failure prevention procedure or a beam failure recovery procedure.

For example, the UE 215 may perform the beam failure recovery procedure to reestablish a connection with the serving base station 205 and select another (e.g., different) beam pair for communications with the serving base station 205. The beam pair may include a beam of the serving base station 205 (e.g., a beam associated with a cell supported by the serving base station 205) and a beam of the UE 215. In some examples, the UE 215 may perform beam management procedures, such as synchronization signal block (SSB) or CSI-RS beam sweeping, SSB and random access channel (RACH) occasion association (e.g., with relatively wide layer one (L1) beams), hierarchical beam refinement procedures (e.g., P1/P2/P3 procedures for downlink beam management or U1/U2/U3 procedures for uplink beam management), and mobility reporting, such as L1-based reporting (e.g., or layer two based (L2-based) reporting). In examples in which the UE 215 detects interruptions in the radio link or detects a radio link failure, the UE 215 may perform a recovery procedure (e.g., a fast master cell group (MCG) link recovery procedure) to reduce a link interruption time or a link failure time. However, in some examples, the UE 215 may determine to perform (e.g., resort to performing) a handover procedure to establish a connection with another base station (e.g., the non-serving base station 206-a, the non-serving base station 206-b, the non-serving base station 206-c, the non-serving base station 206-d, the non-serving base station 206-e, or the non-serving base station 206-f). That is, the UE 215 may perform a handover procedure and select a cell supported by the other base station.

A beam failure recovery procedure may include mobility reporting (e.g., reference signal measurement and reporting) as part of a cell selection or cell reselection process. In some examples, reference signal measurement reporting for non-serving cells, such as L1-based or L2-based reporting, may include (e.g., support) L1 reference signal received power (L1-RSRP) multi-beam measurement or reporting enhancements for inter-cell beam management and inter-cell multiple transmission and reception point (mTRP). For example, L1-based reporting may support L1-based event-driven beam reporting for inter-cell beam management and inter-cell mTRP or medium access control-control element (MAC-CE) based event-driven beam reporting for inter-cell beam management and inter-cell mTRP. In some examples, event-driven beam reporting, such as L1-based event-driven beam reporting, may not be supported for inter-cell beam management and inter-cell mTRP. Additionally or alternatively, L1-RSRP multi-beam measurement or reporting enhancements for inter-cell mobility (e.g., L1-centric or L2-centric inter-cell mobility) and inter-cell mTRP may support L1-based event-driven reporting based on a secondary cell (SCell) beam failure recovery framework or layer three based (L3-based) event-driven reporting (e.g., or a reporting procedure analogous to L3-based event-driven reporting).

In some examples, L3-based reporting (e.g., higher layer reporting) may be relatively slow compared to L1-based reporting (e.g., lower layer reporting). For example, L3-based reporting may include filtering of L1 measurements (e.g., to reduce the effect of fast fading and short-term variations in the measured reference signals), such as L1-RSRP measurements or L1-signal-to-interference-plus-noise ratio (L1-SINR) measurements, and result in an increased latency for L3-based reporting compared to L1-based reporting. Accordingly, as the geographic coverage area of cells decreases (e.g., for high frequency communications, such as millimeter wavelength communications) L3-based reporting may not be suitable. As such, the wireless communications system 200 may support L1-based mobility reporting (e.g., rather than L3-based mobility reporting), such as L1-based event-driven reporting.

For L1-based event-driven reporting, the UE 215 may monitor (e.g., continually) reference signals of the serving cell (e.g., supported by the serving base station 205) and one or more non-serving cells (e.g., supported by a respective non-serving base station 206). For example, the serving cell may configure the UE 215 with a set of non-serving cell reference signals to be monitored (e.g., in addition to the serving cell reference signals to be monitored). In some examples, such monitoring (e.g., including performing and reporting measurements of the non-serving cell reference signals) may be power consuming (e.g., may result in increased power consumption) and reduced the performance of the UE 215. Additionally or alternatively, the monitoring may be overhead consuming (e.g., may result in increased overhead associated with configuring or updating the set of reference signal to be monitored) and complex (e.g., the UE 215 may not be capable of determining which reference signals of the configured set to monitor).

In some examples of L1-based event-driven reporting, the UE 215 may be triggered to perform the L1-based reporting (e.g., the L1-based mobility reporting) based on a threshold (e.g., a single serving cell reference signal received power (RSRP) threshold). The threshold may be configured (e.g., by the serving base station 205) or defined at the UE 215. For example, the UE 215 may be triggered to send an L1-based mobility report (e.g., a report include L1-RSRP measurements of reference signals) for one or more non-serving cells to the serving cell based on the quality of service provided by the serving cell failing to satisfy the threshold (e.g., an event). However, in some examples, using a threshold to trigger mobility reporting may not reduce the processing associated with determining which reference signals (e.g., of the set) are to be monitored. As such, to reduce overhead associated with determining which reference signals are to be monitored, the UE 215 may be provided side information (e.g., base station codebooks or locations). However, such side information may be complex due to different beam forming procedures being implemented at different base stations, changes in the location of the UE 215, and cell-planning geometries, among other factors. Therefore, methods which enable the UE 215 to determine when to perform such measurement and reporting, which non-serving cells for which to perform such measurement and reporting, which reference signals within those non-serving cells (e.g., of the set of reference signals configured by the serving base station 205) for which to perform such measurement and reporting, or any combination thereof, may be desirable.

For example, the UE 215 may use artificial intelligence (e.g., machine learning models) to determine aspects of L1-based mobility reporting (e.g., when and how to trigger L1-RSRP or L1-SINR measurement and reporting) for non-serving cell reference signals. That is, the UE 215 may measure and report (e.g., and optionally signal with transmission configuration indication (TCI) states) reference signals associated with non-serving cells (e.g., non-serving cell reference signals). In some examples, such methods (e.g., with relatively low complexity models) may reduce power consumption (e.g., at the UE 215) associated with L1-mobility reporting and dynamic signaling (e.g., at the serving base station 205) used to configure the measurements (e.g., the set of reference signals to be measured and reported).

As illustrated in the example of FIG. 2, the UE 215 may use machine learning models to determine (e.g., with increased efficiency) aspects of mobility reporting (e.g., mobility measurement reporting) for the UE 215. For example, the UE 215 may be configured with one or multiple machine learning based models that may output decisions regarding mobility measurement reporting (e.g., whether or how to trigger L1-RSRP or L1-SINR measurement or reports) associated with reference signals from non-serving cells. In other words, the machine learning models may output decisions regarding mobility measurement reporting for serving cells associated with cell identifiers different from the cell identifier of the activated serving cell or the serving cell for reporting the measurement results (e.g., the serving cell supported by the serving base station 205). In some examples, a cell identifier may include a PCID or a VCID. As described herein, a cell identifier associated with an activated serving cell may be referred to as a serving cell identifier and a cell identifier associated with a non-activated cell (e.g., a non-activated serving cell) may be referred to as a non-serving cell identifier.

For example, the UE 215 may establish communications with a serving cell (e.g., supported by the serving base station 205) that may be associated with a serving cell identifier different from each non-serving cell identifier of the non-serving cells (e.g., supported by a respective non-serving base station 206) surrounding the serving cell (e.g., and the UE 215). The UE 215 may use one or multiple machine learning models to determine outputs associated with mobility measurement reporting for the UE 215 and perform the mobility measurement reporting based on the outputs. In some examples, the decisions output by the one or multiple machine learning models may indicate whether the UE 215 may perform measurements associated with the non-serving cells (e.g., each non-serving cell associated with a set of non-serving cell identifiers indicated to the UE 215 by the serving base station 205), whether to report the measurements associated with each non-serving cell of the set of non-serving cells, one or more non-serving cells within the set of non-serving cells for performing or reporting the measurements, one or more reference signals of the one or more non-serving cells for performing the measurements, or any combination thereof.

For example, the output of a machine learning model may include at least one of a first output, a second output, or a third output. The first output may indicate whether measurements (e.g., L1-RSRP measurements or L1-SINR measurements) associated with non-serving cell reference signals may be measured, reported, or both. That is the first output may indicate whether the UE 215 may trigger non-serving cell reference signal measurement or reporting. In some examples, if an output of a machine learning model includes the first output and indicates for the UE 215 to perform and report measurements associated with the set of non-serving cells, the UE 215 may measure (e.g., or report) all reference signals from each non-serving cell identified in a channel state information (CSI) resource setting associated with the set of non-serving cells (e.g., a CSI resource setting for non-serving cell L1-RSRP or L1-SINR reporting). The CSI resource setting for non-serving cells may be indicated, such as via a CSI-ResourceConfig information element (IE), to the UE 215 by the serving cell (e.g., the serving base station 205 supporting the serving cell).

For example, if the output of the machine learning model includes the first output and indicates for the UE to perform measurements or reporting for non-serving cells, the UE 215 may perform or report measurements for reference signals indicated by the CSI resource setting and associated with each non-serving cell supported by a respective non-serving base stations 206. In other examples, if the output of the machine learning model includes the first output and indicates for the UE 215 to refrain from performing or reporting the measurements associated with the set of non-serving cells, the UE 215 may perform or report measurements for each serving cell reference signal 220. In some examples, the UE 215 may (e.g., optionally) report the determined triggering (e.g., or non-triggering) of non-serving cell reference signal measurement or reporting when reporting measurements (e.g., L1-RSRP measurements or L1-SINR measurements) for non-serving cells or for the serving cell.

The second output of a machine learning model may indicate non-serving cell identifiers (e.g., PCIDs) associated with non-serving cells for which the UE 215 may perform reference signals measurement or reporting. For example, the second output may indicate one or more non-serving cell identifiers (e.g., a cell identifier of a non-serving cell supported by the non-serving base station 206-a, a cell identifier of a non-serving cell supported by the non-serving base station 206-b, and a cell identifier of a non-serving cell supported by the non-serving base station 206-c) for which the UE 215 may perform reference signal measurement and reporting. In some examples, if the output of the machine learning model includes the second output and indicates one or more non-serving cell identifiers, the UE 215 may measure (e.g., or report) selected reference signals based on the determined (e.g., indicated) non-serving cell identifiers. That is, the UE 215 may perform or report measurements on reference signals indicated in the CSI resource setting for the one or more non-serving cells indicated by the second output.

For example, if the output of the machine learning model includes the second output and indicates a cell identifier associated with the non-serving cell supported by the non-serving base station 206-a, a cell identifier associated with the non-serving cell supported by the non-serving base station 206-b, and a cell identifier associated with the non-serving cell supported by the non-serving base station 206-c, the UE 215 may monitor (e.g., perform or report measurements for) each reference signal indicated by the CSI resource setting for the non-serving cell supported by the non-serving base station 206-a, the non-serving cell supported by the non-serving base station 206-b, and the non-serving cell supported by the non-serving base station 206-c. That is, reference signals associated with a non-serving cell supported by the non-serving base station 206-d, a non-serving cell supported by the non-serving base station 206-e, and a non-serving cell supported by the non-serving base station 206-f may not be measured or reported by the UE 215. In some examples, the UE 215 may (e.g., optionally) report the determined non-serving cell identifiers (e.g., the cell identifier associated with the non-serving cell supported by the non-serving base station 206-a, the cell identifier associated with the non-serving cell supported by the non-serving base station 206-b, and the cell identifier associated with the non-serving cell supported by the non-serving base station 206-c when reporting measurements (e.g., L1-RSRP measurements or L1-SINR measurements) for non-serving cells or for the serving cell. In some examples, the machine learning model may output the first output and the second output. Additionally or alternatively, the UE 215 may use a machine learning model that may provide the second output based on being configured to determine the second output or based on being provided an indication of the first output.

The third output of a machine learning model may indicate which reference signals (e.g., of the reference signals indicated in the CSI resource setting for the one or more non-serving cells indicated by the second output) may be measured or included in the report (e.g., a triggered mobility report). For example, the third output may indicate one or more reference signal identifiers associated with the non-serving cell supported by the non-serving base station 206-a, the non-serving cell supported by the non-serving base station 206-b, and the non-serving cell supported by the non-serving base station 206-c for which the UE 215 may perform and report measurements on. That is, the third output may indicate reference signal identifiers for each non-serving cell reference signal 221.

In some examples, if the output of the machine learning model includes the third output and indicates one or multiple reference signal identifiers associated with the one or more non-serving cells (e.g., indicated by the second output), the UE 215 may measure (e.g., or report) selected reference signals based on the determined (e.g., identified) reference signal identifiers. That is, the UE 215 may perform or report measurements on reference signals indicated by the third output and identified in the CSI resources setting for the one or more non-serving cells indicated by the second output. In some examples, the UE 215 may (e.g., optionally) report the determined reference signals (e.g., indicated by the third output) and the associated non-serving cell identifiers (e.g., PCIDs identified in the second output) when reporting measurements (e.g., L1-RSRP measurements or L1-SINR measurements) for non-serving cells or for the serving cell. In some examples, the machine learning model may output the first output, the second output, and the third output. Additionally or alternatively, the UE 215 may use a machine learning model that may provide the third output based on being configured to determine the third output or based on being provided an indication of the first output and the second output.

In some examples, the output of a machine learning model (e.g., the first output, the second output, or the third output) may include one or multiple periodicities (e.g., recommended periodicities) for measurement and reporting (e.g., associated with the L1-RSRP or L1-SINR reporting) for non-serving cell reference signals. In some examples, the UE may (e.g., optionally) report the output periodicity via MAC-CE or may include the output periodicity in a report to the serving cell (e.g., a CSI report associated with L1-RSRP measurements or L1-SINR measurements for serving cell reference signals or in a CSI report associated with L1-RSRP measurements or L1-SINR measurements for non-serving cell reference signals).

In some examples, the input for a machine learning model may include cell identifiers (e.g., PCIDs) associated with one or more non-serving cells, reference signal identifiers associated with the serving cell or the one or more non-serving cells, beam quality metrics correspond to the reference signal identifiers, or any combination thereof. For example, the machine learning model inputs may include at least one of a first input, a second input, or a third input. The first input may include a set or a subset of reference signal identifiers associated with the serving cell and the corresponding beam quality metrics. In some examples, a beam quality metric may include RSRP, signal-to-interference-plus-noise ratio (SINR), power delay profile, angle of arrival, or any combination thereof. The second input may include reference signal identifiers associated with a subset of non-serving cell identifiers (e.g., cell identifiers associated with non-serving cells) indicated via the CSI resource setting for non-serving cells (e.g., for non-serving cell L1-RSRP measurement reporting or L1-SINR measurement reporting). The third input may include a subset of reference signal identifiers, and the corresponding beam quality metrics, associated with a subset of reference signals indicated via the CSI resource setting for non-serving cells (e.g., for non-serving cell L1-RSRP measurement reporting or L1-SINR measurement reporting). In some examples, the subset of reference signals may be identified by (e.g., associated with) non-serving cell identifiers (e.g., indicated via the CSI resource ceding for non-serving cells). Additionally or alternatively, the UE may identify the subset of non-serving cell identifiers based on a configuration (e.g., indicated by the serving base station 205) or implementation at the UE 215. In some examples, the input for a machine learning model (e.g., the first input, the second input, or the third input) may include upper layer traffic load information, crosslink interference measurements, sidelink measurements, or UE position information. In some examples, crosslink interference measurements may be performed if the UE supports full-duplex. For example, neighboring communication devices (e.g., UEs) may perform full-duplex communications (e.g., or half-duplex time division duplexing (TDD)) concurrently such that uplink communications transmitted by a first UE and downlink communications received by a second (e.g., neighboring) UE may overlap and cause crosslink interference.

In some examples, multiple machine learning models may be configured, such that the machine learning models used by the UE 215 may depend on the serving cell of the UE 215 (e.g., different machine learning models may be associated with different cell identifiers). For example, the machine learning models associated with the cell identifier of the serving cell supported by the serving base station 205 may be different from (e.g., or the same as) the machine learning models associated with the cell identifier of the non-serving cells supported by one or more non-serving base stations 206. Additionally or alternatively, multiple machine learning models may be configured, such that the machine learning models used by the UE 215 may depend on a target non-serving cell identifier (e.g., a cell identifier of a target non-serving cell for a handover procedure) or a non-serving cell identifier grouping (e.g., different machine learning models may be associated with different target non-serving cell identifiers or different non-serving cell identifier groupings).

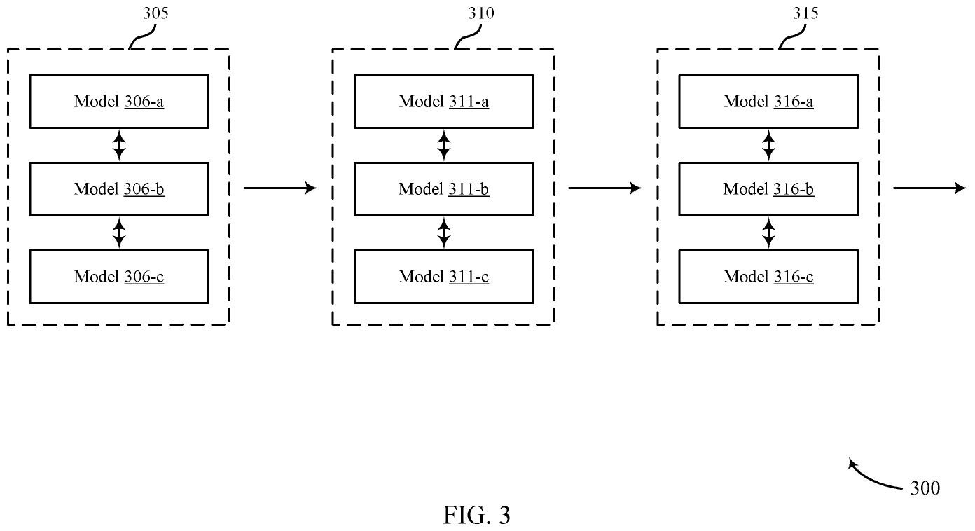

FIG. 3 illustrates an example of a multi-stage model procedure 300 that supports mobility reporting for non-serving cells based on machine learning in accordance with aspects of the present disclosure. The multi-stage model procedure 300 may be implemented by one or more aspects of the wireless communications system 100. For example, the multi-stage model procedure 300 may be implemented by a UE or a base station, which may be an example of the corresponding devices described with reference to FIGS. 1 and 2.

As illustrated in the example of FIG. 3, a UE may use multi-stage machine learning models to determine aspects of mobility reporting (e.g., mobility measurement reporting) for non-serving cells. For example, a first output may be determined by a first type of machine learning model (e.g., a model type 305), a second output may be determined by a second type of machine learning model (e.g., a model type 310), and a third output may be determined by a third type of machine learning model (e.g., a model type 315). In some examples, the first output (e.g., determined by the model type 305), the second output (e.g., determined by the model type 310), and the third output (e.g., determined by the model type 315) may be examples of the corresponding outputs described with reference to FIG. 2.

In some examples, the UE may use multiple machine learning models to sequentially determine multi-stage outputs. For example, a machine learning model of the model type 305 (e.g., a model 306-a, a model 306-b, or a model 306-c) may output input options for a machine learning model of the model type 310 (e.g., a model 311-a, a model 311-b, or a model 311-c). That is, the input for the second type of machine learning model (e.g., the model type 310) may be determined based on the output of the first type of machine learning model (e.g., the model type 305). For example, the first type of machine learning model may output serving cell reference signal identifiers (e.g., identifiers of synchronization signal blocks) and the corresponding beam quality metrics (e.g., RSRP measurements), which may be used as input for the second type of machine learning model. Additionally or alternatively, a machine learning model of the model type 310 (e.g., the model 311-a, the model 311-b, or the model 311-c) may output input options for a model of the model type 315 (e.g., a model 316-a, a model 316-b, or a model 316-c). That is, the input for the third type of machine learning model (e.g., the model type 315) may be determined based on the output of the first type of machine learning model (e.g., the model type 305), the second type of machine learning model (e.g., the model type 310), or both.

For example, the second type of machine learning model may output reference signal identifiers, and the corresponding beam quality metrics (e.g., RSRP measurements), associated with non-serving cell identifiers (e.g., PCIDs of the non-serving cells), which may be used (e.g., in addition to the output of the first type of machine learning model) as input for the third type of machine learning model. In some examples, if the output of a machine learning model of the first type (e.g., one or more models 306) indicates for the UE to refrain from performing and reporting the measurements associated with non-serving cells the UE may refrain from running a model associated with the second output (e.g., one or more models 311) or refrain from running a model associated with the third output (e.g., one or more models 316). Additionally or alternatively, the UE may refrain from running another model associated with the first output (e.g., one or more models 306).

In some examples, the output of a machine learning model may indicate for the UE to switch machine learning models. For example, a machine learning model (e.g., one or more models 306, one or more models 311, or one or more models 316) may output a decision indicating for the UE to switch from a first (e.g., initial or currently used) machine learning model to another (e.g., different) machine learning model determined by the output. In some examples, the output may indicate for the UE to switch to a machine learning model of a different type or to a different machine learning model of a same type (e.g., as the machine learning model providing the output). For example, a machine learning model of the model type 305 (e.g., one or more models 306) may output a decision indicating for the UE to switch to a machine learning model of model type 310 (e.g., or model type 315) or may output a decision indicating for the UE to switch to another machine learning model of model type 305 (e.g., another model 306). In some examples, a decision indicating for the UE to switch models may be referred to as a rigid decision.

In some examples, rather than outputting a rigid decision (e.g., whether to switch models) a machine learning model may output a probability associated with the rigid decision (e.g., a probability that the UE may switch machine learning models). In such examples, the UE may determine to switch machine learning models based on whether the probability output by the first machine learning model (e.g., the initial or currently used machine learning model) satisfies a threshold. In some examples, the threshold for determine whether the UE may switch machine learning models may be configured by the base station supporting the serving cell. In some examples, the UE may (e.g., optionally) report the decision regarding whether the UE may switch models to the base station. For example, the UE may report the rigid decision (e.g., that the UE switch models or that the UE did not switch models) or the probability output by the first machine learning model. For example, the UE may report the rigid decision or the probability output by the first machine learning model via MAC-CE or via bits (e.g., additional bits) in a report to the serving cell (e.g., a CSI report for L1-RSRP measurements or L1-SINR measurements for serving cell reference signals).

For example, the UE may use the first type of machine learning model with a first input, such as reference signal identifiers of reference signals (e.g., SSBs) associated with the serving cell (e.g., the activated serving cell). The first type of machine learning model may output a probability that the UE may switch to a second machine learning model. The second machine learning model may be associated with inputs that may include reference signals identifiers of additional reference signals (e.g., additional SSBs) associated with non-serving cells. That is, the second machine learning model may be associated with inputs that may include reference signal identifiers associated with cell identifiers (e.g., PCIDs) different from the cell identifier of the activated serving cell. The second machine learning model may be of a same type (e.g., or a different type) as the first machine learning model. In some examples, a first threshold associated with the probability of the UE switching from the first type of machine learning model to a second machine learning model may be configured by the base station (e.g., supporting the activated serving cell). For example, the base station may configure the UE with a threshold hold to aid in the decision of whether the UE may switch machine learning models.

Additionally or alternatively, the second machine learning model may output a probability that the UE may switch from the second machine learning model to a third machine learning model. The third machine learning model may be associated with inputs that may include reference signal identifiers of additional reference signals (e.g., additional SSBs) associated with non-serving cells different from the non-serving cells indicated used as input for the second machine learning model. That is, the third machine learning model may be associated with inputs that may include reference signal identifiers associated with cell identifiers (e.g., PCIDs) different from the cell identifier of the activated serving cell and the cell identifiers of the non-serving cells used as input for the second machine learning model). The third machine learning model may be of a same type (e.g., or a different type) as the second machine learning model. In some examples, a second threshold associated with the probability of the UE switching from the second machine learning model to a third machine learning model may be configured by the base station (e.g., supporting the activated serving cell). In some examples (e.g., upon determining the output of the second machine learning model), the UE may report the rigid decision or the probability output by the second machine learning model via MAC-CE or via bits (e.g., additional bits) in a report to the serving cell (e.g., a CSI report for L1-RSRP measurements or L1-SINR measurements for serving cell reference signals or a CSI report for L1-RSRP or L1-SINR measurements for non-serving cell reference signals).

In some examples, the UE may report the decision (e.g., that the UE switched models or that the UE did not switch models) by indicating the machine learning model or machine learning model type to the serving cell. For example, the UE may transmit a report (e.g., a CSI report for L1-RSRP measurements or L1-SINR measurements for serving cell reference signals or a CSI report for L1-RSRP or L1-SINR measurements for non-serving cell reference signals) to the serving cell that may include a number of bits (e.g., two bits) that may indicate an identifier of the machine learning model or the type of machine learning model used (e.g., currently being used) by the UE. Additionally or alternatively, the UE may indicate the machine learning model or the type of machine learning model used by the UE to the serving cell via MAC-CE.

In some examples, a first (e.g., initial or current) machine learning model used by the UE may be based on a configuration from the base station supporting the serving cell (e.g., the serving base station). For example, the base station may indicate (e.g., signal), to the UE, a machine learning model or a machine learning model type to be used by the UE for determining aspects of mobility measurement reporting for non-serving cells. In some examples, the base station may signal the machine learning model or the machine learning model type based on UE feedback (e.g., CSI reports for L1-RSRP measurements or L1-SINR measurements for serving cell reference signals or a CSI report for L1-RSRP measurements or L1-SINR measurements for non-serving cell reference signals). That is, the machine learning model or the machine learning model type indicated to the UE by the base station may be based on information included in the report.

Additionally or alternatively, the base station may indicate the machine learning model or the machine learning model type based on available uplink resources (e.g., within the current or activated serving cell) for transmitting the report (e.g., the CSI reports for L1-RSRP measurement or L1-SINR measurements for serving cell reference signals or a CSI report for L1-RSRP measurement or L1-SINR measurements for non-serving cell reference signals). Additionally or alternatively, the base station may indicate the machine learning model to the UE based on an indication (e.g., recommendation) of a machine learning model by the UE or one or more UE capabilities (e.g., indicated to the serving base station via a UE capability report).

In some examples, the methods described herein may be extended to L3-based mobility reporting. For example, the method described herein may be used by the UE for performing (e.g., and reporting) L3-based mobility measurements, such as while the UE may be in an inactive mode (e.g., an RRC indicated mode indicated via an RRC RRC_INACTIVE IE) or an idle mode (e.g., an RRC idle mode indicated via an RRC_IDLE IE).

The machine learning models (e.g., the models 306, the models 311, and the models 316) may be based on a hidden Markov model. For example, the model outputs (e.g., the hidden Markov model outputs) may indicate hidden states that may be defined as whether the reporting (e.g., reference signal measurement or reporting for non-serving cells) may be triggered, based on observations from the model inputs. That is, hidden states of a hidden Markov model (e.g., the output) may indicate, based on observations of the model inputs, whether the UE may perform reference signal measurement or reporting for non-serving cells. Additionally or alternatively the machine learning models may be neural networks, such as a recurrent neural network (RNN), a convolutional neural network (CNN), a deep neural network (deep-NN), a long short-term memory (LSTM) neural network, or a gated recurrent unit (GRU) neural network.

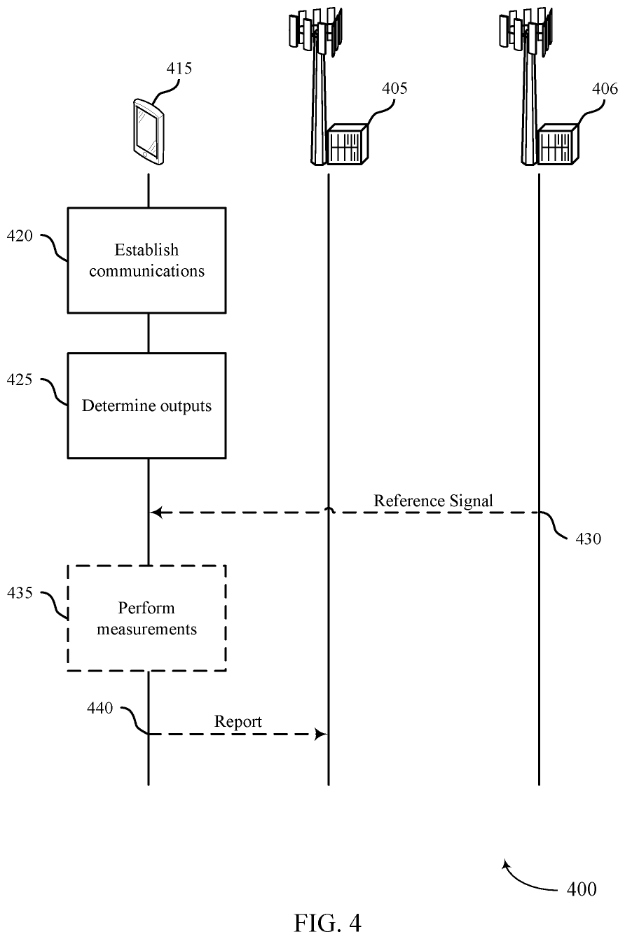

FIG. 4 illustrates an example of a process flow 400 that supports mobility reporting for non-serving cells based on machine learning in accordance with aspects of the present disclosure. The process flow 400 may implement or be implemented by one or more aspects of the wireless communications system 100 and the wireless communications system 200. For example, the process flow 400 may include a UE 415, which may be an example of a UE described with reference to FIGS. 1 and 2. The process flow 400 may also include a serving base station 405 and a non-serving base station 406, which may be an example of a base station described with reference to FIGS. 1 and 2. In the example of FIG. 4, the serving base station 405 may be a base station supporting a serving cell (e.g., an activated serving cell), whereas the non-serving base station 406 may be a base station supporting a non-serving cell (e.g., a non-activated serving cell). In the following description of the process flow 400, operations between the UE 415, the serving base station 405, and the non-serving base station 406 may occur in a different order or at different times than as shown. Some operations may also be omitted from the process flow 400, and other operations may be added to the process flow 400.

At 420, the UE 415 may establish communications between the UE 415 and a serving cell (e.g., supported by the serving base station 405). The serving cell may be different than each non-serving cell of a set of non-serving cells for the UE 415. For example, the non-serving cell supported by the non-serving base station 406 may be associated with a cell identifier different from a cell identifier associated with the serving cell (e.g., the activated serving cell) supported by the serving base station 405.

At 425, the UE 115 may use one or more machine learning models to determine one or more outputs associated with mobility measurement reporting for the UE 115. The one or more outputs may include a first output, a second output, a third output, or any combination thereof. The first output, the second output, and the third output may be examples of the corresponding outputs described with reference to FIGS. 2 and 3. For example, the one or more outputs may indicate whether the UE 415 may perform measurements associated with the set of non-serving cells, whether the UE 415 may report the measurements associated with the set of non-serving cells, one or more non-serving cells within the set of non-serving cells for which the UE 415 may perform or report the measurements, one or more reference signals of the one or more non-serving cells for which the UE 415 may perform or report the measurements, or any combination thereof.

In some examples, the UE 415 may perform the mobility measurement reporting based on the one or more outputs. For example, the one or more outputs may indicate for the UE 415 to perform and report reference signal measurements for the non-serving cell supported by the non-serving base station 406. In some examples, at 430, the non-serving cell supported by the non-serving base station 406 may transmit one or more reference signals to the UE 415. The one or more reference signals may be associated with a reference signal identifier indicated to the UE 415 in a CSI resource setting for non-serving cells received from the serving base station 405. At 435, the UE 415 may perform measurements for the one or more reference signals. At 440, the UE 415 may transmit, to the serving cell supported by the serving base station 405, a report indicating the measurements for the one or more reference signals, one or more identifiers for the one or more non-serving cells (e.g., supported by the non-serving base station 406), one or more identifiers for the one or more reference signals, or any combination thereof.

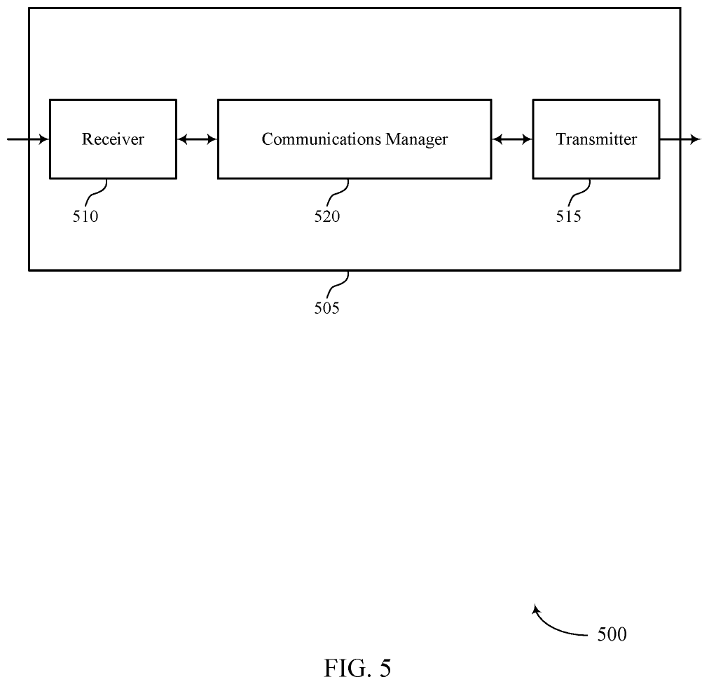

FIG. 5 shows a block diagram 500 of a device 505 that supports mobility reporting for non-serving cells based on machine learning in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to mobility reporting for non-serving cells based on machine learning). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mobility reporting for non-serving cells based on machine learning). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of mobility reporting for non-serving cells based on machine learning as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE (e.g., the device 505) in accordance with examples as disclosed herein. For example, the communications manager 520 may be configured as or otherwise support a means for establishing communications between the UE and a serving cell, the serving cell different than each non-serving cell of a set of non-serving cells for the UE. The communications manager 520 may be configured as or otherwise support a means for using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The communications manager 520 may be configured as or otherwise support a means for performing the mobility measurement reporting based on the one or more outputs.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

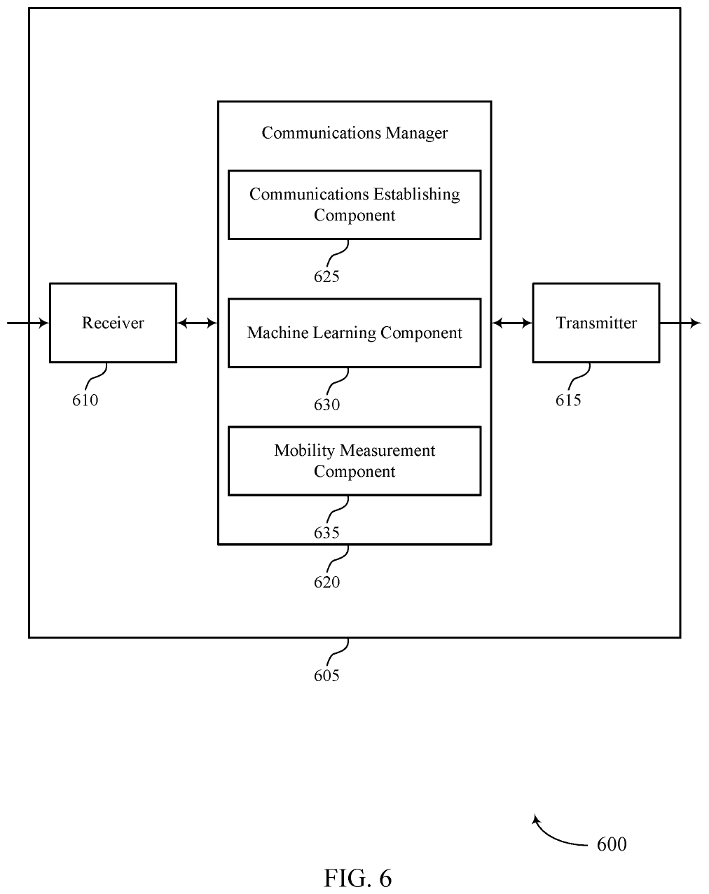

FIG. 6 shows a block diagram 600 of a device 605 that supports mobility reporting for non-serving cells based on machine learning in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to mobility reporting for non-serving cells based on machine learning). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to mobility reporting for non-serving cells based on machine learning). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of mobility reporting for non-serving cells based on machine learning as described herein. For example, the communications manager 620 may include a communications establishing component 625, a machine learning component 630, a mobility measurement component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE (e.g., the device 605) in accordance with examples as disclosed herein. The communications establishing component 625 may be configured as or otherwise support a means for establishing communications between the UE and a serving cell, the serving cell different than each non-serving cell of a set of non-serving cells for the UE. The machine learning component 630 may be configured as or otherwise support a means for using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The mobility measurement component 635 may be configured as or otherwise support a means for performing the mobility measurement reporting based on the one or more outputs.

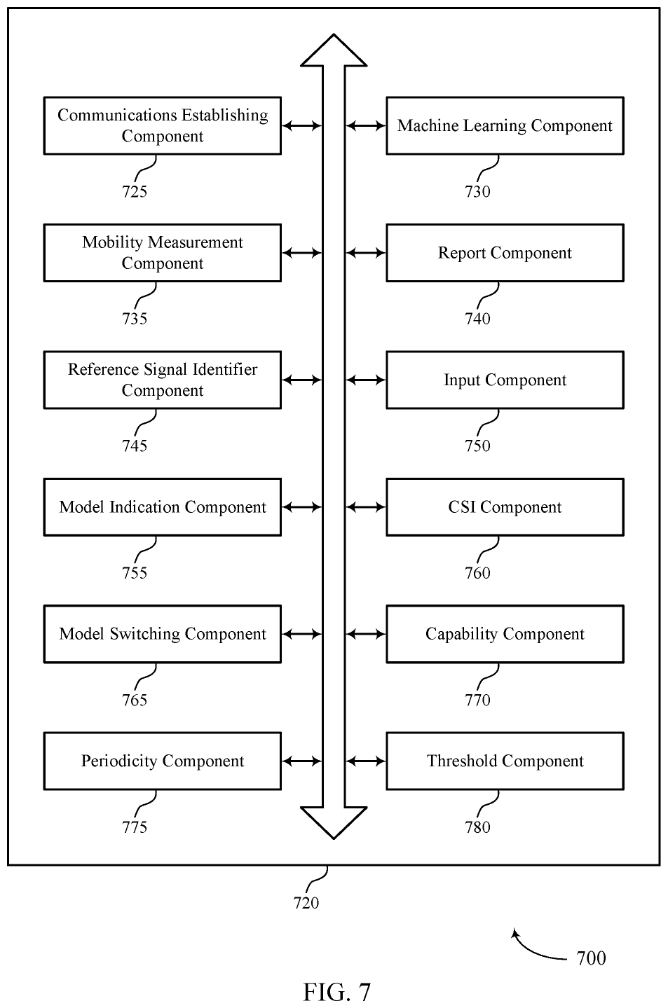

FIG. 7 shows a block diagram 700 of a communications manager 720 that supports mobility reporting for non-serving cells based on machine learning in accordance with aspects of the present disclosure. The communications manager 720 may be an example of aspects of a communications manager 520, a communications manager 620, or both, as described herein. The communications manager 720, or various components thereof, may be an example of means for performing various aspects of mobility reporting for non-serving cells based on machine learning as described herein. For example, the communications manager 720 may include a communications establishing component 725, a machine learning component 730, a mobility measurement component 735, a report component 740, a reference signal identifier component 745, an input component 750, a model indication component 755, a CSI component 760, a model switching component 765, a capability component 770, a periodicity component 775, a threshold component 780, or any combination thereof. Each of these components may communicate, directly or indirectly, with one another (e.g., via one or more buses).

The communications manager 720 may support wireless communication at a UE in accordance with examples as disclosed herein. The communications establishing component 725 may be configured as or otherwise support a means for establishing communications between the UE and a serving cell, the serving cell different than each non-serving cell of a set of non-serving cells for the UE. The machine learning component 730 may be configured as or otherwise support a means for using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The mobility measurement component 735 may be configured as or otherwise support a means for performing the mobility measurement reporting based on the one or more outputs.

In some examples, where the one or more outputs indicate for the UE to perform and report the measurements associated with the set of non-serving cells, the mobility measurement component 735 may be configured as or otherwise support a means for performing, for each non-serving cell of the set of non-serving cells, one or more measurements based on each reference signal indicated by a CSI resource setting associated with the set of non-serving cells and received from the serving cell.

In some examples, the report component 740 may be configured as or otherwise support a means for transmitting, to the serving cell, a report indicating the one or more measurements, the one or more outputs that indicate for the UE to perform and report the measurements associated with the set of non-serving cells, or both.

In some examples, to support performing the mobility measurement reporting, the mobility measurement component 735 may be configured as or otherwise support a means for performing one or more measurements for each of the one or more non-serving cells based on the one or more outputs, where the one or more measurements are based on each reference signal indicated by a CSI resource setting associated with the set of non-serving cells and received from the serving cell, and where the one or more non-serving cells include a subset of the set of non-serving cells. In some examples, to support performing the mobility measurement reporting, the report component 740 may be configured as or otherwise support a means for transmitting, to the serving cell, a report indicating the one or more measurements for each of the one or more non-serving cells, one or more identifiers for each of the one or more non-serving cells, or both.

In some examples, to support performing the mobility measurement reporting, the mobility measurement component 735 may be configured as or otherwise support a means for performing one or more measurements for each of the one or more reference signals based on the one or more outputs, where the one or more reference signals including a subset of reference signals indicated by a CSI resource setting associated with the one or more non-serving cells and received from the serving cell. In some examples, to support performing the mobility measurement reporting, the report component 740 may be configured as or otherwise support a means for transmitting, to the serving cell, a report indicating the measurements for the one or more reference signals, one or more identifiers for the one or more non-serving cells, one or more identifiers for the one or more reference signals, or any combination thereof.

In some examples, each non-serving cell of the set of non-serving cells is associated with a cell identifier different from a cell identifier associated with the serving cell. In some examples, the serving cell includes an activated serving cell.

In some examples, the reference signal identifier component 745 may be configured as or otherwise support a means for identifying one or more reference signal identifiers and one or more measurement values associated with each of the one or more reference signal identifiers, where the one or more reference signal identifiers are associated with the serving cell, a subset of non-serving cells of the set of non-serving cells, a subset of reference signals associated with the subset of non-serving cells, or any combination thereof. In some examples, the input component 750 may be configured as or otherwise support a means for inputting the one or more reference signal identifiers and the one or more measurement values associated with each of the one or more reference signal identifiers into the one or more machine learning models, where the one or more outputs are based on the inputting. In some examples, the one or more measurement values include reference signal received power values, signal-to-interference-plus-noise ratio values, power delay profile values, angle of arrival values, or any combination thereof.

In some examples, the CSI component 760 may be configured as or otherwise support a means for receiving, from the serving cell, a CSI resource setting for non-serving cell measurement mobility reporting, the CSI resource setting indicating the subset of non-serving cells, the subset of reference signals associated with the subset of non-serving cells, or both, where identifying the one or more reference signal identifiers and the one or more measurement values associated with each of the one or more reference signal identifiers is based on receiving the CSI resource setting.

In some examples, the input component 750 may be configured as or otherwise support a means for inputting one or more additional inputs into the one or more machine learning models, the one or more additional inputs including at least one of traffic load information associated with the communications between the UE and the serving cell, crosslink interference measurement values associated with crosslink interference at the UE, the serving cell, or both, sidelink measurement values associated with sidelink communications at the UE, UE position information, or any combination thereof, where the one or more outputs are further based on the one or more additional inputs. In some examples, each machine learning model of the one or more machine learning models is associated with a respective serving cell identifier, a respective non-serving cell identifier, a respective non-serving cell identifier group, or any combination thereof.

In some examples, to support using the one or more machine learning models to determine the one or more outputs associated with the mobility measurement reporting for the UE, the machine learning component 730 may be configured as or otherwise support a means for using a first machine learning model associated with a first machine learning model type to determine a first output associated with the mobility measurement reporting for the UE, the first output indicating for the UE to perform and report the measurements associated with the set of non-serving cells. In some examples, to support using the one or more machine learning models to determine the one or more outputs associated with the mobility measurement reporting for the UE, the machine learning component 730 may be configured as or otherwise support a means for using a second machine learning model associated with a second machine learning model type to determine a second output associated with the mobility measurement reporting of the UE, the second output indicating the one or more non-serving cells of the set of non-serving cells for performing or reporting the measurements, where an input of the second machine learning model includes the first output, and where performing the mobility measurement reporting is based on the second output.

In some examples, the machine learning component 730 may be configured as or otherwise support a means for using a third machine learning model associated with a third machine learning model type to determine a third output associated with the mobility measurement reporting of the UE, the third output indicating the one or more reference signals of the one or more non-serving cells for performing the measurements, where the input of the third machine learning model includes at least one of the first output and the second output, and where performing the mobility measurement reporting is based on the third output.

In some examples, the machine learning component 730 may be configured as or otherwise support a means for refraining from running a first machine learning model associated with a first output that indicates the one or more non-serving cells within the set of non-serving cells for performing or reporting the measurements, refraining from running a second machine learning model associated with a second output that indicates the one or more reference signals of the one or more non-serving cells for performing the measurements, or both.

In some examples, to support using the one or more machine learning models to determine the one or more outputs associated with the mobility measurement reporting for the UE, the machine learning component 730 may be configured as or otherwise support a means for using a first machine learning model of a first machine learning model type to determine a first output. In some examples, to support using the one or more machine learning models to determine the one or more outputs associated with the mobility measurement reporting for the UE, the machine learning component 730 may be configured as or otherwise support a means for using a second machine learning model to determine a second output that is included in the one or more outputs, the second machine learning model associated with the first machine learning model type or a second machine learning model type different from the first machine learning model type.

In some examples, the first output includes an indication for the UE to switch from the first machine learning model to the second machine learning model. In some examples, using the second machine learning model to determine the second output is based on the indication for the UE to switch. In some examples, the indication includes a probability associated with the UE switching from the first machine learning model to the second machine learning model. In some examples, using the second machine learning model to determine the second output is based on the probability satisfying a threshold.

In some examples, the threshold component 780 may be configured as or otherwise support a means for receiving an indication of the threshold from the serving cell. In some examples, the model switching component 765 may be configured as or otherwise support a means for transmitting, to the serving cell, an indication that the UE switched from the first machine learning model to the second machine learning model.

In some examples, the model indication component 755 may be configured as or otherwise support a means for receiving, from the serving cell, an indication of the one or more machine learning models or a machine learning model type associated with the one or more machine learning models, where using the one or more machine learning models to determine the one or more outputs associated with the mobility measurement reporting for the UE is based on the indication.

In some examples, the report component 740 may be configured as or otherwise support a means for transmitting, to the serving cell, a first mobility measurement report, where the indication of the one or more machine learning models or the machine learning model type associated with the one or more machine learning models is based on the first mobility measurement report, an availability of uplink resources, or both.

In some examples, the capability component 770 may be configured as or otherwise support a means for transmitting, to the serving cell, an indication of one or more capabilities associated with the mobility measurement reporting for the UE, where the indication of the one or more machine learning models or the machine learning model type associated with the one or more machine learning models is based on the one or more capabilities.

In some examples, the one or more outputs further indicate a periodicity associated with the mobility measurement reporting for the UE. In some examples, performing and reporting the measurements associated with the set of non-serving cells is based on the periodicity. In some examples, the periodicity component 775 may be configured as or otherwise support a means for transmitting, to the serving cell, an indication of the periodicity associated with the mobility measurement reporting for the UE.

In some examples, to support performing the mobility measurement reporting, the report component 740 may be configured as or otherwise support a means for transmitting, to the serving cell, a mobility measurement report including layer one mobility measurements. In some examples, to support performing the mobility measurement reporting, the report component 740 may be configured as or otherwise support a means for transmitting, to the serving cell, a mobility measurement report including layer three mobility measurements.

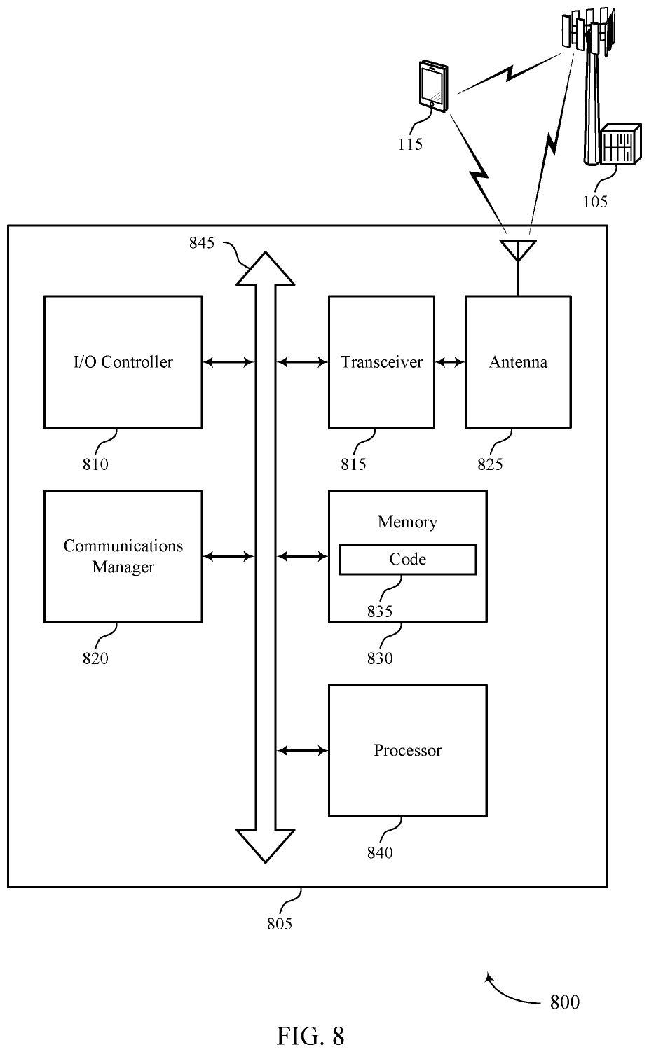

FIG. 8 shows a diagram of a system 800 including a device 805 that supports mobility reporting for non-serving cells based on machine learning in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting mobility reporting for non-serving cells based on machine learning). For example, the device 805 or a component of the device 805 may include a processor 840 and memory 830 coupled with or to the processor 840, the processor 840 and memory 830 configured to perform various functions described herein.

The communications manager 820 may support wireless communication at a UE (e.g., the device 805) in accordance with examples as disclosed herein. For example, the communications manager 820 may be configured as or otherwise support a means for establishing communications between the UE and a serving cell, the serving cell different than each non-serving cell of a set of non-serving cells for the UE. The communications manager 820 may be configured as or otherwise support a means for using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The communications manager 820 may be configured as or otherwise support a means for performing the mobility measurement reporting based on the one or more outputs.

By including or configuring the communications manager 820 in accordance with examples as described herein, the device 805 may support techniques for reduced latency, improved user experience related to reduced processing, reduced power consumption, more efficient utilization of communication resources, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of mobility reporting for non-serving cells based on machine learning as described herein, or the processor 840 and the memory 830 may be otherwise configured to perform or support such operations.

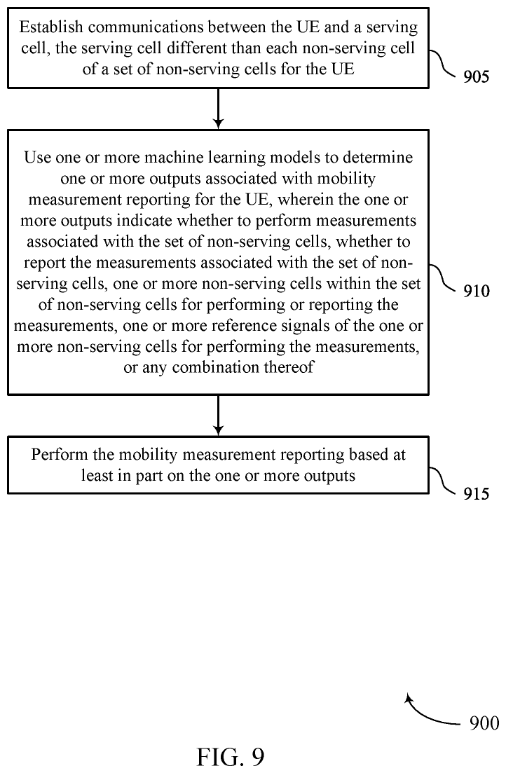

FIG. 9 shows a flowchart illustrating a method 900 that supports mobility reporting for non-serving cells based on machine learning in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include establishing communications between the UE and a serving cell, the serving cell different than each non-serving cell of a set of non-serving cells for the UE. The operations of 905 may be performed in accordance with examples as disclosed herein. In some examples, aspects of the operations of 905 may be performed by a communications establishing component 725 as described with reference to FIG. 7. Additionally or alternatively, means for performing 905 may, but not necessarily, include, for example, antenna 825, transceiver 815, communications manager 820, memory 830 (including code 835), processor 840 and/or bus 845.

At 910, the method may include using one or more machine learning models to determine one or more outputs associated with mobility measurement reporting for the UE, where the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof. The operations of 910 may be performed in accordance with examples as disclosed herein. In some examples, aspects of the operations of 910 may be performed by a machine learning component 730 as described with reference to FIG. 7. Additionally or alternatively, means for performing 910 may, but not necessarily, include, for example, antenna 825, transceiver 815, communications manager 820, memory 830 (including code 835), processor 840 and/or bus 845.

At 915, the method may include performing the mobility measurement reporting based on the one or more outputs. The operations of 915 may be performed in accordance with examples as disclosed herein. In some examples, aspects of the operations of 915 may be performed by a mobility measurement component 735 as described with reference to FIG. 7. Additionally or alternatively, means for performing 915 may, but not necessarily, include, for example, antenna 825, transceiver 815, communications manager 820, memory 830 (including code 835), processor 840 and/or bus 845.

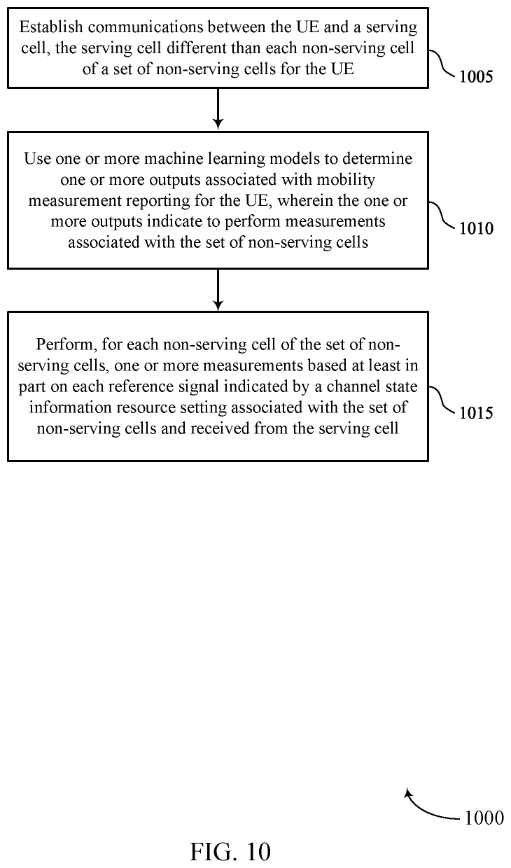

FIG. 10 shows a flowchart illustrating a method 1000 that supports mobility reporting for non-serving cells based on machine learning in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include establishing communications between the UE and a serving cell, the serving cell different than each non-serving cell of a set of non-serving cells for the UE. The operations of 1005 may be performed in accordance with examples as disclosed herein. In some examples, aspects of the operations of 1005 may be performed by a communications establishing component 725 as described with reference to FIG. 7. Additionally or alternatively, means for performing 1005 may, but not necessarily, include, for example, antenna 825, transceiver 815, communications manager 820, memory 830 (including code 835), processor 840 and/or bus 845.

At 1010, the method may include using one or more machine learning models to determine one or more outputs associated with mobility measurement reporting for the UE, where the one or more outputs indicate to perform measurements associated with the set of non-serving cells. The operations of 1010 may be performed in accordance with examples as disclosed herein. In some examples, aspects of the operations of 1010 may be performed by a machine learning component 730 as described with reference to FIG. 7. Additionally or alternatively, means for performing 1010 may, but not necessarily, include, for example, antenna 825, transceiver 815, communications manager 820, memory 830 (including code 835), processor 840 and/or bus 845.

At 1015, the method may include performing, for each non-serving cell of the set of non-serving cells, one or more measurements based on each reference signal indicated by a CSI resource setting associated with the set of non-serving cells and received from the serving cell. The operations of 1015 may be performed in accordance with examples as disclosed herein. In some examples, aspects of the operations of 1015 may be performed by a mobility measurement component 735 as described with reference to FIG. 7. Additionally or alternatively, means for performing 1015 may, but not necessarily, include, for example, antenna 825, transceiver 815, communications manager 820, memory 830 (including code 835), processor 840 and/or bus 845.

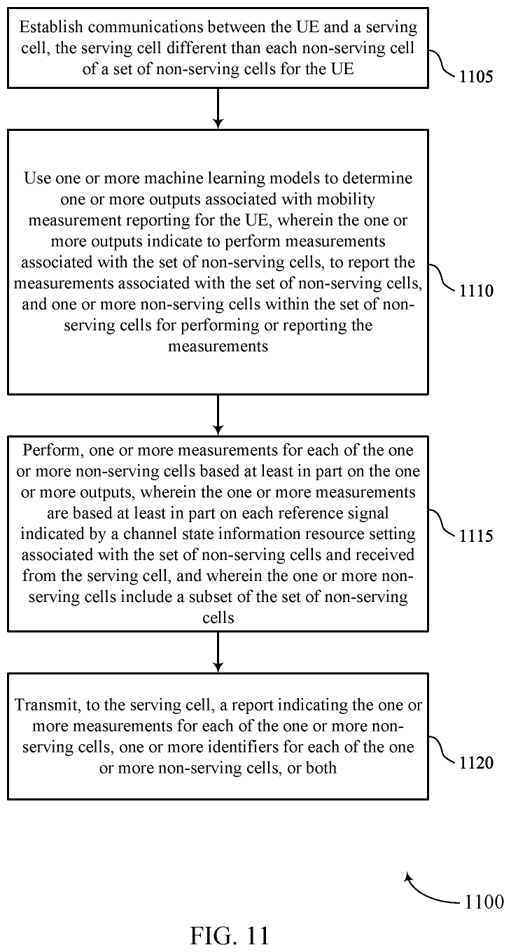

FIG. 11 shows a flowchart illustrating a method 1100 that supports mobility reporting for non-serving cells based on machine learning in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include establishing communications between the UE and a serving cell, the serving cell different than each non-serving cell of a set of non-serving cells for the UE. The operations of 1105 may be performed in accordance with examples as disclosed herein. In some examples, aspects of the operations of 1105 may be performed by a communications establishing component 725 as described with reference to FIG. 7. Additionally or alternatively, means for performing 1105 may, but not necessarily, include, for example, antenna 825, transceiver 815, communications manager 820, memory 830 (including code 835), processor 840 and/or bus 845.

At 1110, the method may include using one or more machine learning models to determine one or more outputs associated with mobility measurement reporting for the UE, where the one or more outputs indicate to perform measurements associated with the set of non-serving cells, to report the measurements associated with the set of non-serving cells, and one or more non-serving cells within the set of non-serving cells for performing or reporting the measurements. The operations of 1110 may be performed in accordance with examples as disclosed herein. In some examples, aspects of the operations of 1110 may be performed by a machine learning component 730 as described with reference to FIG. 7. Additionally or alternatively, means for performing 1110 may, but not necessarily, include, for example, antenna 825, transceiver 815, communications manager 820, memory 830 (including code 835), processor 840 and/or bus 845.

At 1115, the method may include performing one or more measurements for each of the one or more non-serving cells based on the one or more outputs, where the one or more measurements are based on each reference signal indicated by a CSI resource setting associated with the set of non-serving cells and received from the serving cell, and where the one or more non-serving cells includes a subset of the set of non-serving cells. The operations of 1115 may be performed in accordance with examples as disclosed herein. In some examples, aspects of the operations of 1115 may be performed by a mobility measurement component 735 as described with reference to FIG. 7. Additionally or alternatively, means for performing 1115 may, but not necessarily, include, for example, antenna 825, transceiver 815, communications manager 820, memory 830 (including code 835), processor 840 and/or bus 845.

At 1120, the method may include transmitting, to the serving cell, a report indicating the one or more measurements for each of the one or more non-serving cells, one or more identifiers for each of the one or more non-serving cells, or both. The operations of 1120 may be performed in accordance with examples as disclosed herein. In some examples, aspects of the operations of 1120 may be performed by a report component 740 as described with reference to FIG. 7. Additionally or alternatively, means for performing 1120 may, but not necessarily, include, for example, antenna 825, transceiver 815, communications manager 820, memory 830 (including code 835), processor 840 and/or bus 845.

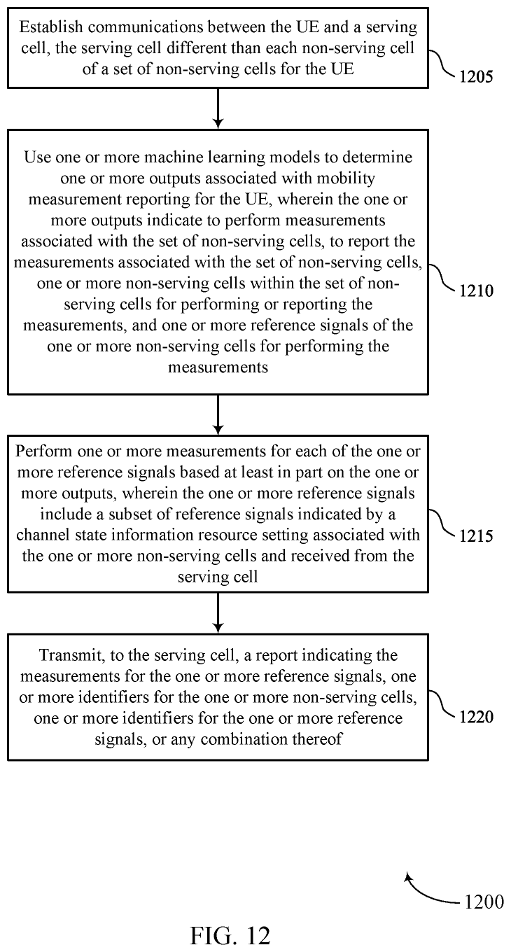

FIG. 12 shows a flowchart illustrating a method 1200 that supports mobility reporting for non-serving cells based on machine learning in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include establishing communications between the UE and a serving cell, the serving cell different than each non-serving cell of a set of non-serving cells for the UE. The operations of 1205 may be performed in accordance with examples as disclosed herein. In some examples, aspects of the operations of 1205 may be performed by a communications establishing component 725 as described with reference to FIG. 7. Additionally or alternatively, means for performing 1105 may, but not necessarily, include, for example, antenna 825, transceiver 815, communications manager 820, memory 830 (including code 835), processor 840 and/or bus 845.

At 1210, the method may include using one or more machine learning models to determine one or more outputs associated with mobility measurement reporting for the UE, where the one or more outputs indicate to perform measurements associated with the set of non-serving cells, to report the measurements associated with the set of non-serving cells, one or more non-serving cells within the set of non-serving cells for performing or reporting the measurements, and one or more reference signals of the one or more non-serving cells for performing the measurements. The operations of 1210 may be performed in accordance with examples as disclosed herein. In some examples, aspects of the operations of 1210 may be performed by a machine learning component 730 as described with reference to FIG. 7. Additionally or alternatively, means for performing 1210 may, but not necessarily, include, for example, antenna 825, transceiver 815, communications manager 820, memory 830 (including code 835), processor 840 and/or bus 845.

At 1215, the method may include performing one or more measurements for each of the one or more reference signals based on the one or more outputs, where the one or more reference signals include a subset of reference signals indicated by a CSI resource setting associated with the one or more non-serving cells and received from the serving cell. The operations of 1215 may be performed in accordance with examples as disclosed herein. In some examples, aspects of the operations of 1215 may be performed by a mobility measurement component 735 as described with reference to FIG. 7. Additionally or alternatively, means for performing 1215 may, but not necessarily, include, for example, antenna 825, transceiver 815, communications manager 820, memory 830 (including code 835), processor 840 and/or bus 845.

At 1220, the method may include transmitting, to the serving cell, a report indicating the measurements for the one or more reference signals, one or more identifiers for the one or more non-serving cells, one or more identifiers for the one or more reference signals, or any combination thereof. The operations of 1220 may be performed in accordance with examples as disclosed herein. In some examples, aspects of the operations of 1220 may be performed by a report component 740 as described with reference to FIG. 7. Additionally or alternatively, means for performing 1220 may, but not necessarily, include, for example, antenna 825, transceiver 815, communications manager 820, memory 830 (including code 835), processor 840 and/or bus 845.

The following provides an overview of aspects of the present disclosure:

Aspect 1: A method for wireless communication at a UE, comprising: establishing communications between the UE and a serving cell, the serving cell different than each non-serving cell of a set of non-serving cells for the UE: using one or more machine learning models to determine one or more outputs associated with mobility measurement reporting for the UE, wherein the one or more outputs indicate whether to perform measurements associated with the set of non-serving cells, whether to report the measurements associated with the set of non-serving cells, one or more non-serving cells within the set of non-serving cells for performing or reporting the measurements, one or more reference signals of the one or more non-serving cells for performing the measurements, or any combination thereof; and performing the mobility measurement reporting based at least in part on the one or more outputs.

Aspect 2: The method of aspect 1, wherein the one or more outputs indicate for the UE to perform and report the measurements associated with the set of non-serving cells, and wherein performing the mobility measurement reporting comprises: performing, for each non-serving cell of the set of non-serving cells, one or more measurements based at least in part on each reference signal indicated by a CSI resource setting associated with the set of non-serving cells and received from the serving cell.

Aspect 3: The method of aspect 2, further comprising: transmitting, to the serving cell, a report indicating the one or more measurements, the one or more outputs that indicate for the UE to perform and report the measurements associated with the set of non-serving cells, or both.

Aspect 4: The method of aspect 1, wherein the one or more outputs indicate the one or more non-serving cells of the set of non-serving cells for performing or reporting the measurements, and wherein performing the mobility measurement reporting comprises: performing one or more measurements for each of the one or more non-serving cells based at least in part on the one or more outputs, wherein the one or more measurements are based at least in part on each reference signal indicated by a CSI resource setting associated with the set of non-serving cells and received from the serving cell, and wherein the one or more non-serving cells comprise a subset of the set of non-serving cells; and transmitting, to the serving cell, a report indicating the one or more measurements for each of the one or more non-serving cells, one or more identifiers for each of the one or more non-serving cells, or both.

Aspect 5: The method of aspect 1, wherein the one or more outputs indicate the one or more reference signals of the one or more non-serving cells for performing the measurements, and wherein performing the mobility measurement reporting comprises: performing one or more measurements for each of the one or more reference signals based at least in part on the one or more outputs, wherein the one or more reference signals comprising a subset of reference signals indicated by a CSI resource setting associated with the one or more non-serving cells and received from the serving cell; and transmitting, to the serving cell, a report indicating the measurements for the one or more reference signals, one or more identifiers for the one or more non-serving cells, one or more identifiers for the one or more reference signals, or any combination thereof.

Aspect 6: The method of any of aspects 1 through 5, wherein each non-serving cell of the set of non-serving cells is associated with a cell identifier different from a cell identifier associated with the serving cell, the serving cell comprises an activated serving cell.

Aspect 7: The method of any of aspects 1 through 6, further comprising: identifying one or more reference signal identifiers and one or more measurement values associated with each of the one or more reference signal identifiers, wherein the one or more reference signal identifiers are associated with the serving cell, a subset of non-serving cells of the set of non-serving cells, a subset of reference signals associated with the subset of non-serving cells, or any combination thereof; and inputting the one or more reference signal identifiers and the one or more measurement values associated with each of the one or more reference signal identifiers into the one or more machine learning models, wherein the one or more outputs are based at least in part on the inputting.

Aspect 8: The method of aspect 7, wherein the one or more measurement values comprise RSRP values, SINR values, power delay profile values, angle of arrival values, or any combination thereof.

Aspect 9: The method of any of aspects 7 through 8, further comprising: receiving, from the serving cell, a CSI resource setting for non-serving cell measurement mobility reporting, the CSI resource setting indicating the subset of non-serving cells, the subset of reference signals associated with the subset of non-serving cells, or both, wherein identifying the one or more reference signal identifiers and the one or more measurement values associated with each of the one or more reference signal identifiers is based at least in part on receiving the CSI resource setting.

Aspect 10: The method of any of aspects 7 through 9, further comprising: inputting one or more additional inputs into the one or more machine learning models, the one or more additional inputs comprising at least one of traffic load information associated with the communications between the UE and the serving cell, crosslink interference measurement values associated with crosslink interference at the UE, the serving cell, or both, sidelink measurement values associated with sidelink communications at the UE, UE position information, or any combination thereof, wherein the one or more outputs are further based at least in part on the one or more additional inputs.

Aspect 11: The method of any of aspects 1 through 10, wherein each machine learning model of the one or more machine learning models is associated with a respective serving cell identifier, a respective non-serving cell identifier, a respective non-serving cell identifier group, or any combination thereof.

Aspect 12: The method of any of aspects 1 through 11, wherein using the one or more machine learning models to determine the one or more outputs associated with the mobility measurement reporting for the UE comprises: using a first machine learning model associated with a first machine learning model type to determine a first output associated with the mobility measurement reporting for the UE, the first output indicating for the UE to perform and report the measurements associated with the set of non-serving cells; and using a second machine learning model associated with a second machine learning model type to determine a second output associated with the mobility measurement reporting of the UE, the second output indicating the one or more non-serving cells of the set of non-serving cells for performing or reporting the measurements, wherein an input of the second machine learning model comprises the first output, and wherein performing the mobility measurement reporting is based at least in part on the second output.

Aspect 13: The method of aspect 12, further comprising: using a third machine learning model associated with a third machine learning model type to determine a third output associated with the mobility measurement reporting of the UE, the third output indicating the one or more reference signals of the one or more non-serving cells for performing the measurements, wherein the input of the third machine learning model comprises at least one of the first output and the second output, and wherein performing the mobility measurement reporting is based at least in part on the third output.

Aspect 14: The method of aspect 1, wherein the one or more outputs indicate for the UE to refrain from performing and reporting the measurements associated with the set of non-serving cells, further comprising: refraining from running a first machine learning model associated with a first output that indicates the one or more non-serving cells within the set of non-serving cells for performing or reporting the measurements, refraining from running a second machine learning model associated with a second output that indicates the one or more reference signals of the one or more non-serving cells for performing the measurements, or both.

Aspect 15: The method of any of aspects 1 through 14, wherein using the one or more machine learning models to determine the one or more outputs associated with the mobility measurement reporting for the UE comprises further comprising: using a first machine learning model of a first machine learning model type to determine a first output; and using a second machine learning model to determine a second output that is included in the one or more outputs, the second machine learning model associated with the first machine learning model type or a second machine learning model type different from the first machine learning model type.

Aspect 16: The method of aspect 15, wherein the first output comprises an indication for the UE to switch from the first machine learning model to the second machine learning model, and using the second machine learning model to determine the second output is based at least in part on the indication for the UE to switch.

Aspect 17: The method of aspect 16, wherein the indication comprises a probability associated with the UE switching from the first machine learning model to the second machine learning model, and using the second machine learning model to determine the second output is based at least in part on the probability satisfying a threshold.

Aspect 18: The method of aspect 17, further comprising: receiving an indication of the threshold from the serving cell.

Aspect 19: The method of any of aspects 15 through 18, further comprising: transmitting, to the serving cell, an indication that the UE switched from the first machine learning model to the second machine learning model.

Aspect 20: The method of any of aspects 1 through 19, further comprising: receiving, from the serving cell, an indication of the one or more machine learning models or a machine learning model type associated with the one or more machine learning models, wherein using the one or more machine learning models to determine the one or more outputs associated with the mobility measurement reporting for the UE is based at least in part on the indication.

Aspect 21: The method of aspect 20, further comprising: transmitting, to the serving cell, a first mobility measurement report, wherein the indication of the one or more machine learning models or the machine learning model type associated with the one or more machine learning models is based at least in part on the first mobility measurement report, an availability of uplink resources, or both.

Aspect 22: The method of any of aspects 20 through 21, further comprising: transmitting, to the serving cell, an indication of one or more capabilities associated with the mobility measurement reporting for the UE, wherein the indication of the one or more machine learning models or the machine learning model type associated with the one or more machine learning models is based at least in part on the one or more capabilities.

Aspect 23: The method of any of aspects 1 through 22, wherein the one or more outputs further indicate a periodicity associated with the mobility measurement reporting for the UE, and performing and reporting the measurements associated with the set of non-serving cells is based at least in part on the periodicity.

Aspect 24: The method of aspect 23, further comprising: transmitting, to the serving cell, an indication of the periodicity associated with the mobility measurement reporting for the UE.

Aspect 25: The method of any of aspects 1 through 24, wherein performing the mobility measurement reporting comprises: transmitting, to the serving cell, a mobility measurement report comprising L1 mobility measurements.

Aspect 26: The method of any of aspects 1 through 25, wherein performing the mobility measurement reporting comprises: transmitting, to the serving cell, a mobility measurement report comprising L3 mobility measurements.

Aspect 27: An apparatus comprising a memory, transceiver, and at least one processor coupled with the memory and the transceiver, the at least one processor configured to cause the apparatus to perform a method of any of aspects 1 through 26.

Aspect 28: An apparatus for wireless communication at a UE, comprising at least one means for performing a method of any of aspects 1 through 26.

Aspect 29: A non-transitory computer-readable medium storing code for wireless communication at a UE, the code comprising instructions executable by a processor to perform a method of any of aspects 1 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
establishing communications between the UE and a serving cell, the serving cell different than each non-serving cell of a set of non-serving cells for the UE;
using one or more machine learning models to determine one or more outputs associated with mobility measurement reporting for the UE, wherein the one or more outputs indicate:
whether to perform measurements associated with the set of non-serving cells,
whether to report the measurements associated with the set of non-serving cells,
one or more non-serving cells within the set of non-serving cells for performing or reporting the measurements,
one or more reference signals of the one or more non-serving cells for performing the measurements, or
any combination thereof; and
performing the mobility measurement reporting based at least in part on the one or more outputs.

2. The method of claim 1, wherein the one or more outputs indicate for the UE to perform and report the measurements associated with the set of non-serving cells, and wherein performing the mobility measurement reporting comprises:
performing, for each non-serving cell of the set of non-serving cells, one or more measurements based at least in part on each reference signal indicated by a channel state information resource setting associated with the set of non-serving cells and received from the serving cell.

3. The method of claim 2, further comprising:
transmitting, to the serving cell, a report indicating the one or more measurements, the one or more outputs that indicate for the UE to perform and report the measurements associated with the set of non-serving cells, or both.

4. The method of claim 1, wherein the one or more outputs indicate the one or more non-serving cells of the set of non-serving cells for performing or reporting the measurements, and wherein performing the mobility measurement reporting comprises:
performing one or more measurements for each of the one or more non-serving cells based at least in part on the one or more outputs, wherein the one or more measurements are based at least in part on each reference signal indicated by a channel state information resource setting associated with the set of non-serving cells and received from the serving cell, and wherein the one or more non-serving cells comprise a subset of the set of non-serving cells; and
transmitting, to the serving cell, a report indicating the one or more measurements for each of the one or more non-serving cells, one or more identifiers for each of the one or more non-serving cells, or both.

5. The method of claim 1, wherein the one or more outputs indicate the one or more reference signals of the one or more non-serving cells for performing the measurements, and wherein performing the mobility measurement reporting comprises:
performing one or more measurements for each of the one or more reference signals based at least in part on the one or more outputs, wherein the one or more reference signals comprising a subset of reference signals indicated by a channel state information resource setting associated with the one or more non-serving cells and received from the serving cell; and
transmitting, to the serving cell, a report indicating the measurements for the one or more reference signals, one or more identifiers for the one or more non-serving cells, one or more identifiers for the one or more reference signals, or any combination thereof.

6. The method of claim 1, wherein each non-serving cell of the set of non-serving cells is associated with a cell identifier different from a cell identifier associated with the serving cell, the serving cell comprises an activated serving cell.

7. The method of claim 1, further comprising:
identifying one or more reference signal identifiers and one or more measurement values associated with each of the one or more reference signal identifiers, wherein the one or more reference signal identifiers are associated with the serving cell, a subset of non-serving cells of the set of non-serving cells, a subset of reference signals associated with the subset of non-serving cells, or any combination thereof; and
inputting the one or more reference signal identifiers and the one or more measurement values associated with each of the one or more reference signal identifiers into the one or more machine learning models, wherein the one or more outputs are based at least in part on the inputting.

8. The method of claim 7, further comprising:
receiving, from the serving cell, a channel state information resource setting for non-serving cell measurement mobility reporting, the channel state information resource setting indicating the subset of non-serving cells, the subset of reference signals associated with the subset of non-serving cells, or both, wherein identifying the one or more reference signal identifiers and the one or more measurement values associated with each of the one or more reference signal identifiers is based at least in part on receiving the channel state information resource setting.

9. The method of claim 1, wherein each machine learning model of the one or more machine learning models is associated with a respective serving cell identifier, a respective non-serving cell identifier, a respective non-serving cell identifier group, or any combination thereof.

10. The method of claim 1, wherein using the one or more machine learning models to determine the one or more outputs associated with the mobility measurement reporting for the UE comprises:
using a first machine learning model associated with a first machine learning model type to determine a first output associated with the mobility measurement reporting for the UE, the first output indicating for the UE to perform and report the measurements associated with the set of non-serving cells; and
using a second machine learning model associated with a second machine learning model type to determine a second output associated with the mobility measurement reporting of the UE, the second output indicating the one or more non-serving cells of the set of non-serving cells for performing or reporting the measurements, wherein an input of the second machine learning model comprises the first output, and wherein performing the mobility measurement reporting is based at least in part on the second output.

11. The method of claim 10, further comprising:
using a third machine learning model associated with a third machine learning model type to determine a third output associated with the mobility measurement reporting of the UE, the third output indicating the one or more reference signals of the one or more non-serving cells for performing the measurements, wherein the input of the third machine learning model comprises at least one of the first output and the second output, and wherein performing the mobility measurement reporting is based at least in part on the third output.

12. The method of claim 1, wherein the one or more outputs indicate for the UE to refrain from performing and reporting the measurements associated with the set of non-serving cells, further comprising:
refraining from running a first machine learning model associated with a first output that indicates the one or more non-serving cells within the set of non-serving cells for performing or reporting the measurements, refraining from running a second machine learning model associated with a second output that indicates the one or more reference signals of the one or more non-serving cells for performing the measurements, or both.

13. The method of claim 1, wherein using the one or more machine learning models to determine the one or more outputs associated with the mobility measurement reporting for the UE, further comprising:
using a first machine learning model of a first machine learning model type to determine a first output; and
using a second machine learning model to determine a second output that is included in the one or more outputs, the second machine learning model associated with the first machine learning model type or a second machine learning model type different from the first machine learning model type.

14. The method of claim 13, wherein the first output comprises an indication for the UE to switch from the first machine learning model to the second machine learning model, and using the second machine learning model to determine the second output is based at least in part on the indication for the UE to switch.

15. The method of claim 14, wherein the indication comprises a probability associated with the UE switching from the first machine learning model to the second machine learning model, and using the second machine learning model to determine the second output is based at least in part on the probability satisfying a threshold.

16. The method of claim 15, further comprising:
receiving an indication of the threshold from the serving cell.

17. The method of claim 13, further comprising:
transmitting, to the serving cell, an indication that the UE switched from the first machine learning model to the second machine learning model.

18. The method of claim 1, further comprising:
receiving, from the serving cell, an indication of the one or more machine learning models or a machine learning model type associated with the one or more machine learning models, wherein using the one or more machine learning models to determine the one or more outputs associated with the mobility measurement reporting for the UE is based at least in part on the indication.

19. The method of claim 18, further comprising:
transmitting, to the serving cell, a first mobility measurement report, wherein the indication of the one or more machine learning models or the machine learning model type associated with the one or more machine learning models is based at least in part on the first mobility measurement report, an availability of uplink resources, or both.

20. The method of claim 18, further comprising:
transmitting, to the serving cell, an indication of one or more capabilities associated with the mobility measurement reporting for the UE, wherein the indication of the one or more machine learning models or the machine learning model type associated with the one or more machine learning models is based at least in part on the one or more capabilities.

21. The method of claim 1, wherein the one or more outputs further indicate a periodicity associated with the mobility measurement reporting for the UE, and performing and reporting the measurements associated with the set of non-serving cells is based at least in part on the periodicity.

22. The method of claim 21, further comprising:
transmitting, to the serving cell, an indication of the periodicity associated with the mobility measurement reporting for the UE.

23. The method of claim 1, wherein performing the mobility measurement reporting comprises:
transmitting, to the serving cell, a mobility measurement report comprising layer one mobility measurements.

24. The method of claim 1, wherein performing the mobility measurement reporting comprises:
transmitting, to the serving cell, a mobility measurement report comprising layer three mobility measurements.

25. An apparatus for wireless communication, comprising:
memory;
a transceiver; and
at least one processor of a user equipment (UE), the at least one processor coupled with the memory and the transceiver, and the at least one processor configured to cause the apparatus to:
establish communications between the UE and a serving cell, the serving cell different than each non-serving cell of a set of non-serving cells for the UE;
use one or more machine learning models to determine one or more outputs associated with mobility measurement reporting for the UE, wherein the one or more outputs indicate:
whether to perform measurements associated with the set of non-serving cells,
whether to report the measurements associated with the set of non-serving cells,
one or more non-serving cells within the set of non-serving cells for performing or reporting the measurements,
one or more reference signals of the one or more non-serving cells for performing the measurements, or
any combination thereof; and
perform the mobility measurement reporting based at least in part on the one or more outputs.

26. The apparatus of claim 25, wherein the one or more outputs indicate for the UE to perform and report the measurements associated with the set of non-serving cells, and wherein, to perform the mobility measurement reporting, the at least one processor is configured to cause the apparatus to:
perform, for each non-serving cell of the set of non-serving cells, one or more measurements based at least in part on each reference signal indicated by a channel state information resource setting associated with the set of non-serving cells and received from the serving cell.

27. The apparatus of claim 26, the at least one processor further configured to cause the apparatus to:
transmit, via the transceiver and to the serving cell, a report indicating the one or more measurements, the one or more outputs that indicate for the UE to perform and report the measurements associated with the set of non-serving cells, or both.

28. The apparatus of claim 25, wherein the one or more outputs indicate the one or more non-serving cells of the set of non-serving cells for performing or reporting the measurements, and wherein, to perform the mobility measurement reporting, the at least one processor is configured to cause the apparatus to:
perform one or more measurements for each of the one or more non-serving cells based at least in part on the one or more outputs, wherein the one or more measurements are based at least in part on each reference signal indicated by a channel state information resource setting associated with the set of non-serving cells and received from the serving cell, and wherein the one or more non-serving cells comprise a subset of the set of non-serving cells; and
transmit, via the transceiver and to the serving cell, a report indicating the one or more measurements for each of the one or more non-serving cells, one or more identifiers for each of the one or more non-serving cells, or both.

29. An apparatus for wireless communication at a user equipment (UE), comprising:
means for establishing communications between the UE and a serving cell, the serving cell different than each non-serving cell of a set of non-serving cells for the UE;
means for using one or more machine learning models to determine one or more outputs associated with mobility measurement reporting for the UE, wherein the one or more outputs indicate:
whether to perform measurements associated with the set of non-serving cells,
whether to report the measurements associated with the set of non-serving cells,
one or more non-serving cells within the set of non-serving cells for performing or reporting the measurements,
one or more reference signals of the one or more non-serving cells for performing the measurements, or
any combination thereof; and
means for performing the mobility measurement reporting based at least in part on the one or more outputs.

30. A non-transitory computer-readable medium storing code for wireless communication at a user equipment (UE), the code comprising instructions executable by a processor to:
establish communications between the UE and a serving cell, the serving cell different than each non-serving cell of a set of non-serving cells for the UE;
use one or more machine learning models to determine one or more outputs associated with mobility measurement reporting for the UE, wherein the one or more outputs indicate:
whether to perform measurements associated with the set of non-serving cells,
whether to report the measurements associated with the set of non-serving cells,
one or more non-serving cells within the set of non-serving cells for performing or reporting the measurements,
one or more reference signals of the one or more non-serving cells for performing the measurements,
or any combination thereof; and
perform the mobility measurement reporting based at least in part on the one or more outputs.
